(19) United States
(12) Patent Application Publication
(10) Pub. No.: US 2012/0290422 A1
(43) Pub. Date: Nov. 15, 2012

(54) SEAMLESSLY CAPTURING TRANSACTIONAL DATA AT THE MERCHANT'S POINT OF SALE ENVIRONMENT AND CREATING ELECTRONIC RECEIPTS, ALL IN REAL-TIME

(76) Inventor: Mick M. Bhinder, Richmond Hill (CA)

(21) Appl. No.: 13/470,431

(22) Filed: May 14, 2012

Related U.S. Application Data
(63) Continuation of application No. PCT/CA2010/001816, filed on Nov. 12, 2010.

(30) Foreign Application Priority Data
Nov. 16, 2009 (CA) 2684434
Jun. 1, 2010 (CA) 2706151

(51) Int. Cl. G06Q 20/20

(52) U.S. Cl. 705/21

(57) ABSTRACT

Series of processes and methods designed to seamlessly capture detailed transactional data from merchants' Point of Sale environments and generate final presentments of electronic receipts for both consumers and merchants, is accessible from their destination accounts, all in real time. Objectives are to: migrate all printed paper receipts to electronic forms; enable customer facing post-sales management capabilities; increase self serve; create new shopping and post-shopping experiences and satisfaction rates; significantly reduce administrative and storage requirements and costs, and provide more time for work productivity. Customers and merchants are able to create various reports and are able to directly submit them from their destination accounts for: expenditure accounting and tax purposes, payment processing, and for other company expenses. Further capabilities include creating: supplementary accounts; spend alerts; merchant driven targeted profile marketing initiatives, and business directory listings with mapping capabilities.

### CROSS-REFERENCE TO RELATED APPLICATIONS

This application is a continuation of International Application No. PCT/CA2010/001816, filed Nov. 12, 2010, which claims priority to Canadian patent application No. 2,684,434, filed Nov. 16, 2009 and Canadian patent application No. 2,706,151, filed Jun. 1, 2010. The entire contents of International Application No. PCT/CA2010/001816, Canadian patent application No. 2,684,434, and Canadian patent application No. 2,706,151 are hereby incorporated by reference.

### FIELD

The embodiments will address the retail Point of Sale (POS) environment, comprising the technological and computer platforms configured to capture transactional data and then to create electronic receipts. The embodiments seamlessly create real-time electronic receipts directly from the POS environment, leveraging the use of electronic transactional data that is greater than Level 1 Merchant Data, providing detailed transactional information.

The embodiments may involve ongoing software and hardware platform developments; including keeping current with state of the art technologies to provide secured access and storage of electronic and transactional data, as well as enabling real-time transmissions and conversions of electronic and transactional data and electronic receipts to the intended locations and account destinations.

### BACKGROUND

In today's commerce environment, every time a transaction takes place between a buyer and a merchant (seller of goods and/or services); the buyer typically receives a paper receipt to show and act as a proof of payment and ownership. In order to provide printed paper receipts with every sales transaction, merchants need a Point of Sale (POS) terminal system, terminal printer, paper receipt rolls and printer ink cartridges; merchants also need to ensure that they have ample stock of paper receipt rolls and ink cartridges.

Through the development and introduction of credit cards into the market, receipts have migrated from being handwritten to now being printed. Having printed paper receipts at the Point of Sale provides thorough key transaction details that need to be captured. Receipts are the very fabric of everyday commerce transactions, as they provide different functions for both consumers and merchants.

For ‘Personal Consumers’ (i.e., buyers who are non-business entities), receipts are:

A proof of payment for the exchange of goods and (or) services rendered by the seller to the buyer.

The titles of ownership for the property obtained in the exchange of transaction.

The means of allowing an unsatisfied customer to exercise a return of goods and (or) complain about services rendered. In return and in accordance to the merchants' Return Policy, they will either be issued with a full monetary value refund, receive an exchange of goods and or services, or receive a credit for future purchases.

A proof of warranty/guarantee for the goods and (or) services purchased.

Paper receipts serve additional functions for ‘Small Medium Enterprises (SME's) and Corporations and their Business Managers’:

Receipts allow business managers, businesses and companies to keep track of their company related expenses, helping them to better manage and monitor their company expenses and budgets.

Employees are mandated to retain their company expense receipts for all of their transactions, so that they can submit these expenses with their employee expense reports.

Employee expense reports containing receipts allow business managers, businesses and companies to identify and monitor employee expenses; and to also enable great accountability between the employer and the employee.

With the generation of receipts and submission of the expense reports, companies can also manage and calculate their tax reconciliations against the expenses.

Receipts play a vital role in business and tax audits. During audit sessions, auditors and accountants typically check through all business documents, reports and statements, including receipts, to ensure that the company's finances are in order and that all expenses, profits and losses are accounted for.

Receipts entail a unique set of requirements and functions for ‘Merchants’. Every time a merchant participates in a sales transaction they have to:

Provide a receipt to the customer to show completion of the sales transaction.

Receipts are proof of exchanging titles of ownership from the merchant to the consumer through the act of a sales transaction.

Ensure there is sufficient available stock of printer rolls and ink cartridges, so that they can produce a receipt for every transaction at a physical POS terminal location. The cost of buying printer supplies may vary depending on foot-traffic to the merchant's business.

If the method of payment is cash, merchants only print off one copy of the receipt, which is given to the customer. If the method of payment is via a credit or debit card, merchants typically print of two copies of the receipt; one copy will go to the customer and the other copy will remain with the merchant. Typically at the end of each business day, merchants will use these copies of receipts to do their daily sales reconciliations and to submit their request for completion of payment on their credit and debit card sales. The purpose of reconciling is to separate each card plastic payment receipt so that they can process all payments relative to American Express®, MasterCard®, Visa® and Debit cards, prior to sending off for batch payment processing/requests.

Merchants need all receipts to calculate the taxes applicable to the sales of their goods and or services, so that they can submit the correct amount of taxes.

Merchants are also required to keep all receipts: (i) in the event they have to deal with a credit card payment dispute (otherwise referred to as a chargeback); (ii) for purposes of preparing for a business and or tax audit, back dating 7 years.

Although receipts prove to be quite important, there nevertheless are challenges too that are associated with them. Business managers, employees, merchants and companies have to manually prepare and process the submission of reports and other types of requests using actual or copies of the paper receipts; they also have to safely keep and store paper receipts for up to 7 years. Merchants have to bear the burden of costs to ensure that there are sufficient stocks of printer receipts supplies. Furthermore, heavily associated with this are impact to costs relating to administration and storage, as well as impacts to work productivity. Also, there are always risks associated with data entry errors, which can occur from the manual submission of the employee expense reports. This can cause a lot of issues in the long run as final calculations may become skewed and lead to inaccurate reporting. Businesses and merchants are also required to keep all documents, statements and receipts related to company expenses for up to 7 years, so that they may be able to prepare for business and tax auditing purposes. If these receipts get lost in the process then the company has no official record of expenses made. Small to mid-sized businesses and merchants typically don't have sophisticated back end office capabilities. For these businesses and merchants of this size, receipt management can be quite administratively intensive.

It is thus advantageous to provide an electronic receipt system that may be targeted at:

Personal consumers—who are seeking convenience and new post sales experiences;

Business managers; business owners; and corporations—who make business related expenses and wish to have a better receipt management process and system; and

Merchants of all sizes—who wish to streamline their receipt management processes and systems, post sales administrative procedures and storage and to save on the costs of buying printer supplies.

### SUMMARY OF THE INVENTION

The embodiments described herein provide in one aspect, a computer implemented system for processing a financial transaction at a point-of-sale terminal, the system comprising

one or more memories for storing information and at least one set of instructions, and

one or more distributed processors for
capturing financial transaction data;
determining a destination account at a remote data storage facility;
sending the financial transaction data to the remote data storage facility;
generating an electronic receipt from the financial transaction data; and
storing the electronic receipt at the destination account at the remote data storage facility;
wherein
   the destination account is associated with an account type; and
   the electronic receipt is configurable to contain a variable amount of merchant level data based on the account type.

The embodiments described herein provide in another aspect, a computer implemented system for processing a financial transaction at a point-of-sale terminal, the system comprising

one or more memories for storing information and at least one set of instructions, and

one or more distributed processors for
determining multiple destination accounts at a remote data storage facility;
generating at least one electronic receipt for each of the multiple destination accounts; and
sending the at least one electronic receipt to each of the multiple destination accounts to the remote data storage facility.

The embodiments described herein provide in a further aspect, a computer implemented system for storing electronic receipts comprising

a merchant module operable to store merchant account data;

a consumer module operable to store consumer account data;

a business manager module operable to store business account data;

a receipts module operable to store electronic receipts associated with the merchant account data and the consumer account data; and

a hypermedia interface for interacting with the electronic receipts.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1A is a block diagram of a system for generating electronic receipts at a point-of-sale terminal;

FIG. 1B is a flowchart diagram illustrating the steps of generating electronic receipts at a point-of-sale terminal;

FIGS. 2A and 2C are flowchart diagrams illustrating the steps of capturing financial transaction information at a point-of-sale environment for payment methods requiring and not requiring external authorization and settlement respectively;

FIGS. 2B and 2D are block diagrams illustrating exemplary methods of payment requiring and not requiring external authorization and settlement respectively;

FIG. 3A is a block diagram illustrating functions provided by a consumer destination account environment;

FIGS. 3B-3G are example screenshots of a consumer destination account environment;

FIG. 4A is a block diagram illustrating functions provided by a business manager destination account environment;

FIG. 4B is an example screenshot of a business manager destination account environment;

FIGS. 5A and 5C are block diagrams illustrating operations provided by a personal and business supplementary accounts respectively;

FIG. 5B is an example screenshot of a personal supplementary account environment;

FIG. 6A is a block diagram illustrating functions provided by a merchant destination account environment;

FIGS. 6B and 6C are example screenshots of a merchant destination account environment;

FIG. 7 is an example schematic diagram illustrating searchable fields of electronic receipts and available reports that may be generated therefrom; and

FIG. 8 is a flowchart diagram illustrating the steps of creating a new account at the POS environment.

### DETAILED DESCRIPTION

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), at least one input device, and at least one output device. For example and without limitation, the programmable computers may be a personal computer, laptop, personal data assistant, cellular telephone, smart-phone device and wireless hypermedia device.

Program code is applied to input data to perform the functions described herein and generate output information. The output information is applied to one or more output devices, in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein. The subject system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

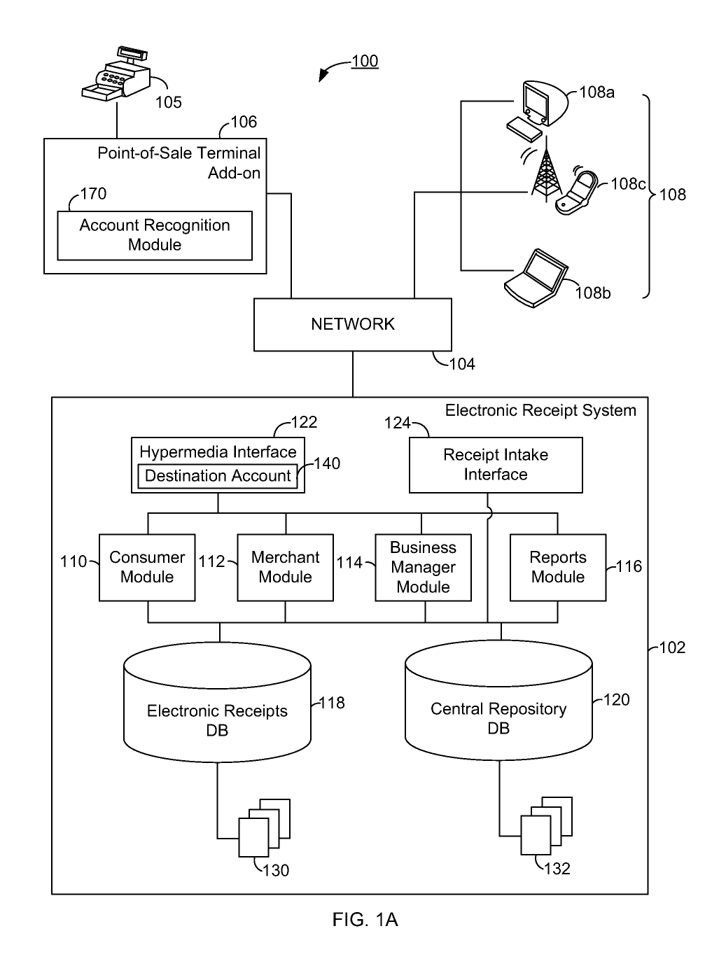

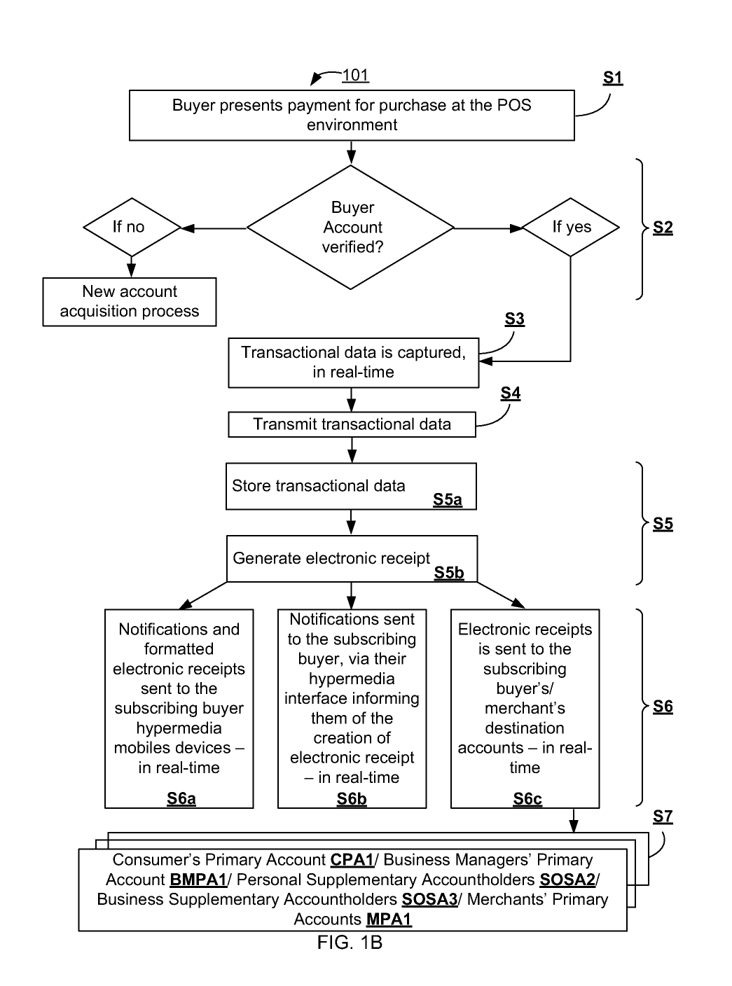

Referring to FIG. 1A, therein illustrated is a system for generating electronic receipts, referred to generally as 100. Point-of-Sale Terminal 105 may be any location where a buyer and a merchant interact, wherein a buyer provides payment in exchange for a good or service. For example, point-of-sale terminal 105 may be provided at any retail location, office, or other suitable location and or environment where a financial transaction may be processed. Point-of-sale terminal 105 can further include laptops, computer devices, smart phones, other forms of hypermedia devices/interfaces, or any other suitable devices or platforms that are capable of enabling e-commerce payments.

Point-of-Sale terminal 105 may have embedded within it, point-of-sale add-on 106, and may be operatively connected to a communications network 104 (such as the Internet) for sending transaction data from financial transactions occurring at point-of-sale terminal add-on 106 to electronic receipt system 102. Electronic receipt system 102 may also be operatively connected to network 104 to receive financial transaction data sent from point-of-sale terminal add-on 106.

Information stored on electronic receipt system 102 may be accessible by various computing platforms 108 also operatively connected to communications network 104. For example, such computing platforms may include desktop computers 108a, laptop computers 108b or wireless communication device 108c.

It will be understood by one skilled in the art that connections to communications network 104 may be wired, wireless or any combination thereof. For example, desktop computer 108a or laptop computer 108b may be connected to network 104 through wireless local area network (WLAN) technologies (e.g., “Wi-Fi”) or through a physical network connection to a computer network router or switch (e.g., Ethernet). Wireless communication device 108c may be connected to network 104 through mobile cellular networks, which may be operable to additionally provide cellular-specific services such as SMS text message notification.

When a financial transaction takes place, account recognition module 170 in POS terminal add-on 106 may be configured to recognize the account information of the buyer (consumer (A) or business manager (BM)) in the transaction. In one embodiment, the buyer account may be directly derivable from the payment method account (e.g., a buyer account being determined from the credit card account used to pay for the purchase) such that a buyer may pay with their payment method without providing specific information related to the buyer's registered account on electronic receipt system 102. In alternate embodiments, account recognition module 170 may be linked to hardware components (not shown) operable to provide information about an account registered with electronic receipt system 102. For example, such hardware component may include any type of hardware token reader such as a barcode scanner, a magnetic stripe reader, a smart card reader, an alphanumeric keypad or other suitable methods known in the art of securely reading in account information.

As discussed below, the account information recognized by account recognition module 170 may be linked to supplementary accounts associated with the buyer.

POS terminal add-on 106 may also be configured to be associated with the seller (a merchant account) such that when financial transaction data is sent from POS terminal add-on 106 to electronic receipt system 102, the generated electronic receipt may be sent to the proper accounts registered in electronic receipt system 102.

In some embodiments, account recognition module 170 may also contain programmatic logic for creating a new account if no destination account can be determined to be associated with a buyer at the financial transaction.

Electronic receipt system 102 may comprise a receipt intake interface 124 and a hypermedia interface 122 for allowing outside users and systems to access electronic receipt system 102. Electronic receipt system 102 may also comprise programmatic modules for providing programmatic logic to enable various account environments. These may comprise consumer module 110, merchant module 112, business manager module 114 and reports module 116. Electronic receipt system 102 may further comprise persistent storage mechanisms. This may include electronic receipts database 118 for storing electronic receipts 130 and central repository database 120 for storing financial transaction data 132 captured from point-of-sale terminal 105.

It will be understood by those skilled in the art that the various components of electronic receipt system 102 that provides persistent storage of financial transaction data 132 and electronic receipts 130 may be characterized as a remote data storage facility or a data storage facility.

Receipt intake interface 124 receives financial transaction information 132 from point of sale terminal add-on 106. This information is stored directly into central repository database 120. Thorough and complete financial transaction data 132 is stored to enable the generation of electronic receipts 130 containing variable amounts of merchant level data according to the type of account environment (consumer (A), business manager (BM) or merchant (M)).

Electronic receipts database 118 stores electronic receipts 130 generated from financial transaction data 132 stored in central repository database 120. Each electronic receipt may comprise variable amounts of merchant level data, and may be searchable according to various fields by reports module 116 (discussed below).

It will be understood by those skilled in the art that central repository database 120 and electronic receipts database 118 may be organized and structured according to a suitable schema for organizing such information. Such databases may be provided by known database technologies in the art such as Microsoft SQL Server, IBM DB2 or MySQL. It will be further understood that although central repository database 120 and electronic receipts database 118 are illustrated as databases, that any other suitable persistent storage technologies may also be used to accomplish similar tasks (e.g., a persistent file format).

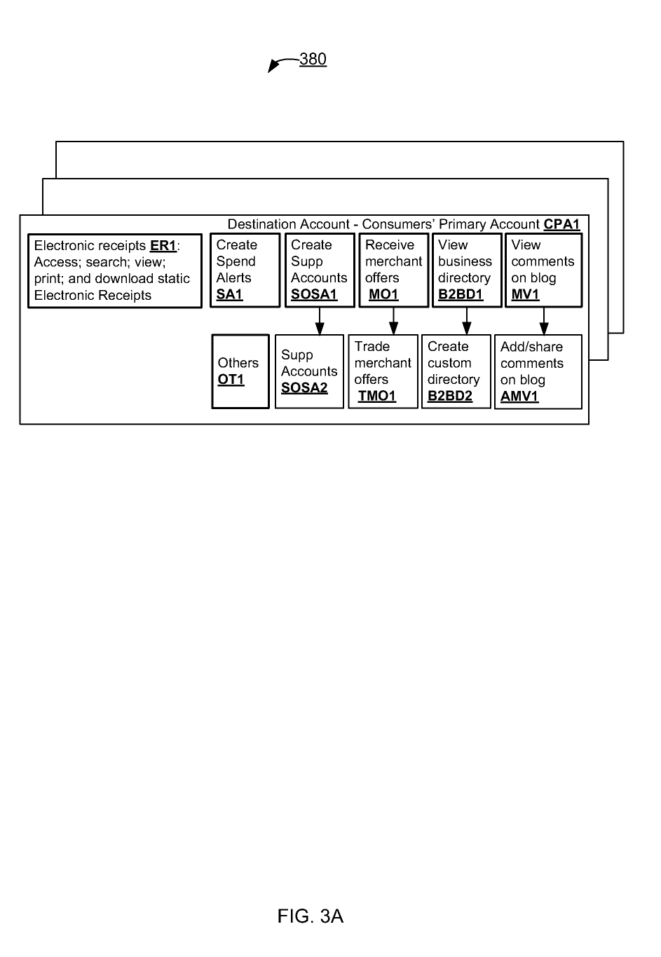

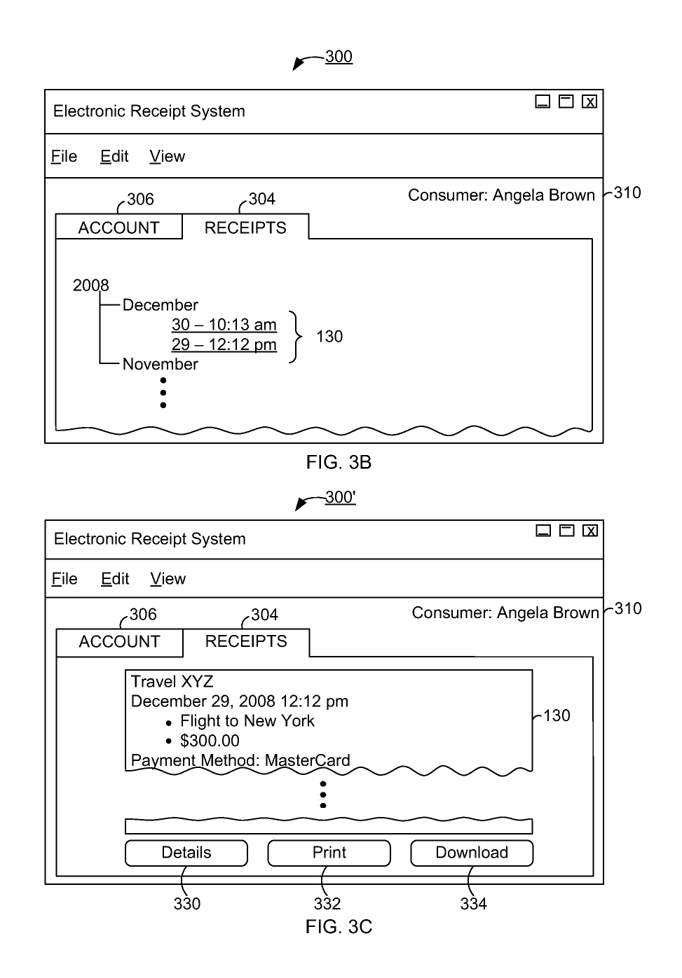

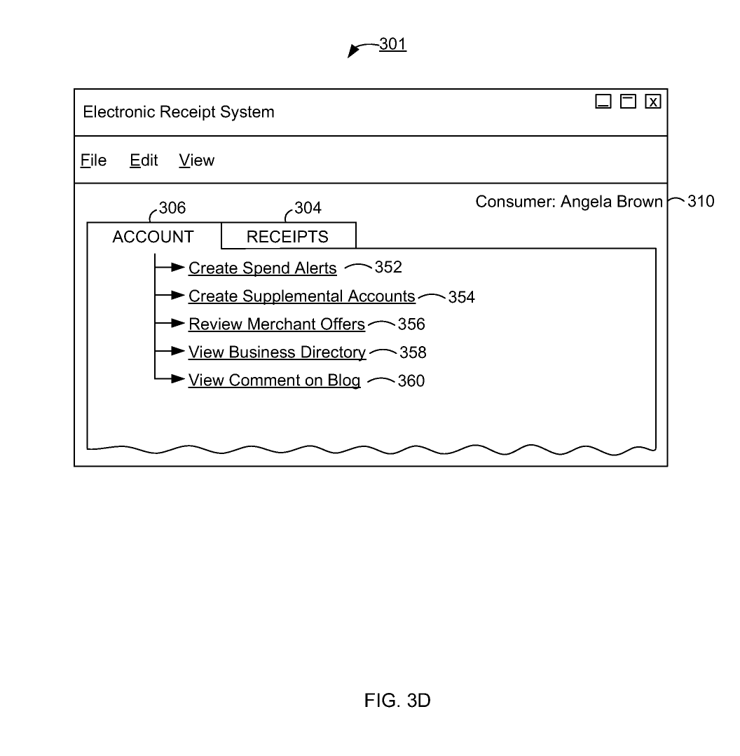

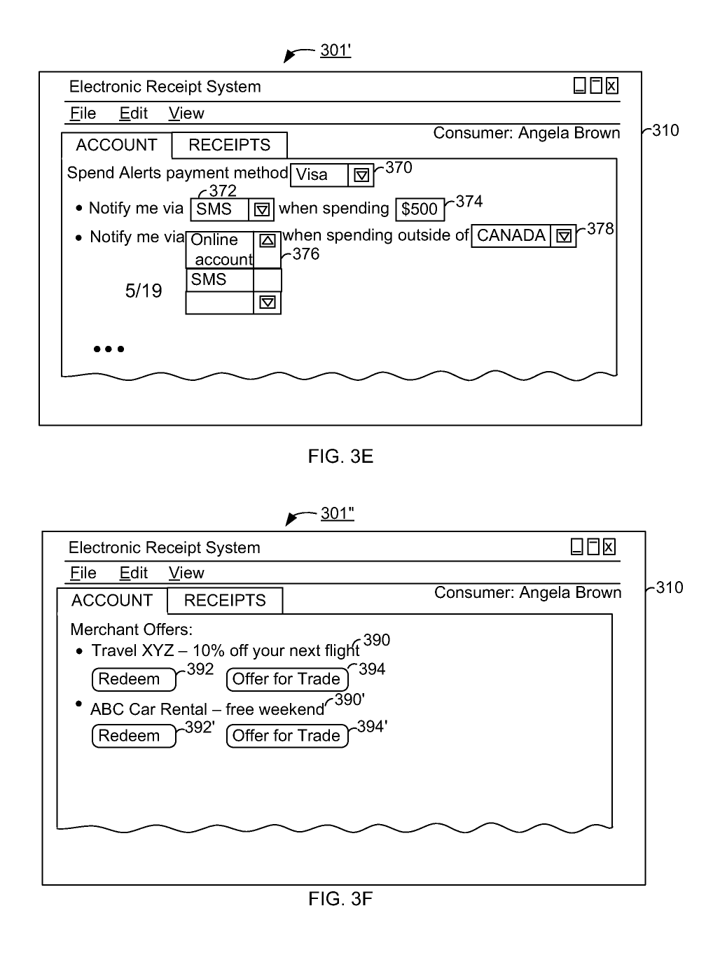

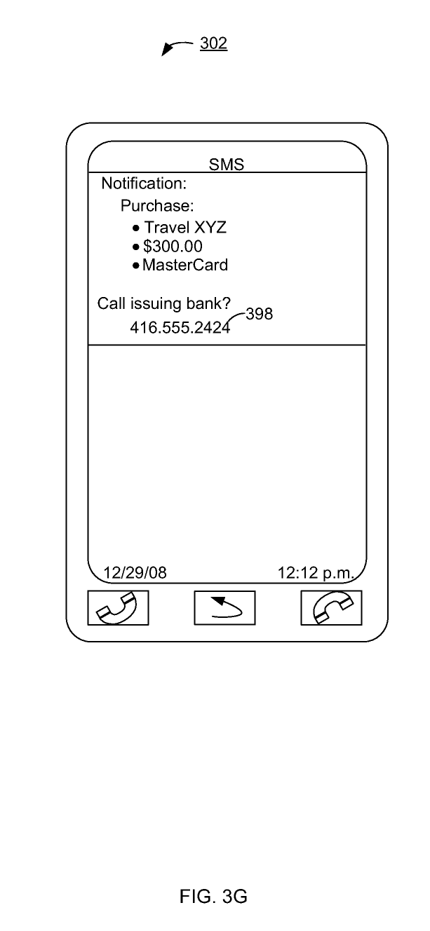

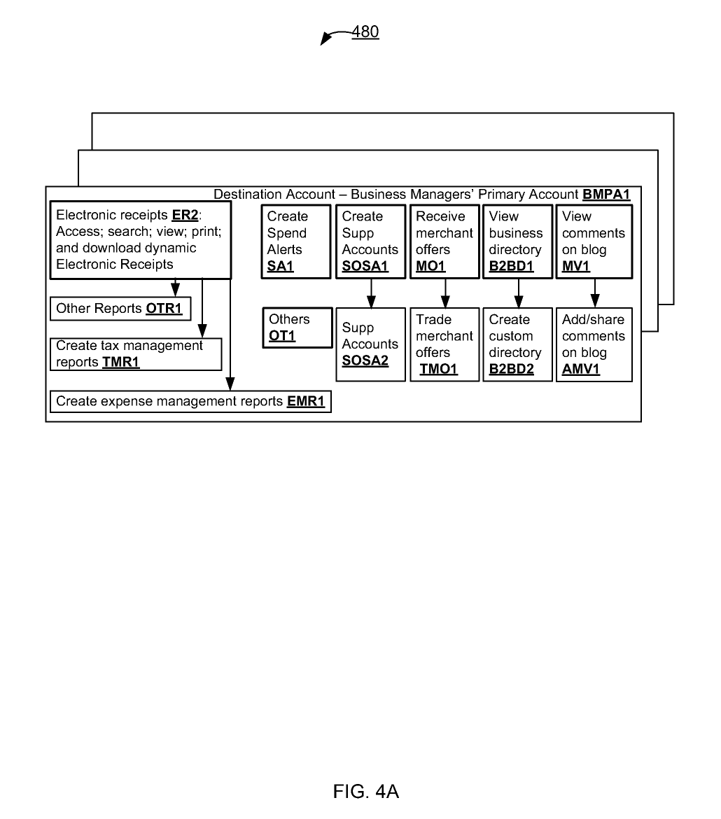

Consumer module 110 may be operable to store and access account information related to a registered consumer, i.e., consumer account data. Such information may include contact information, payment information, preferred information or other suitable information. Consumer module 110 may also be operatively connected to hypermedia interface 122 to provide information for a consumer destination account environment (CPA1, described below) to computing environments 108 (example screenshots of which are provided in FIGS. 3B-G, described in detail below) To enable the functions available in consumer destination account environment (CPA1), consumer module 110 may also be operatively connected to electronic receipts database 118 to allow access to electronic receipts 130, and to central repository database 120 to allow access to financial transaction data 132.

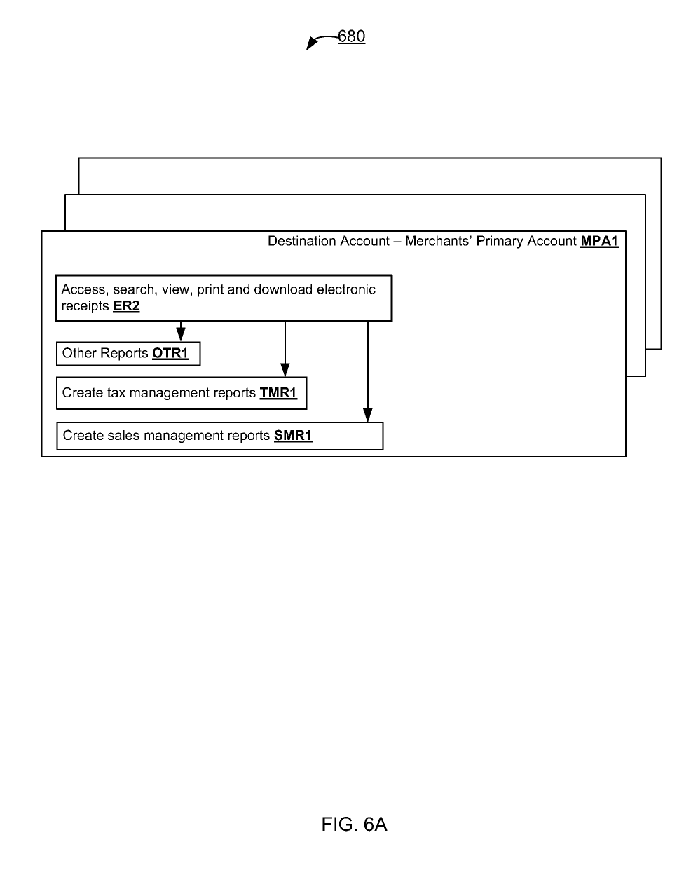

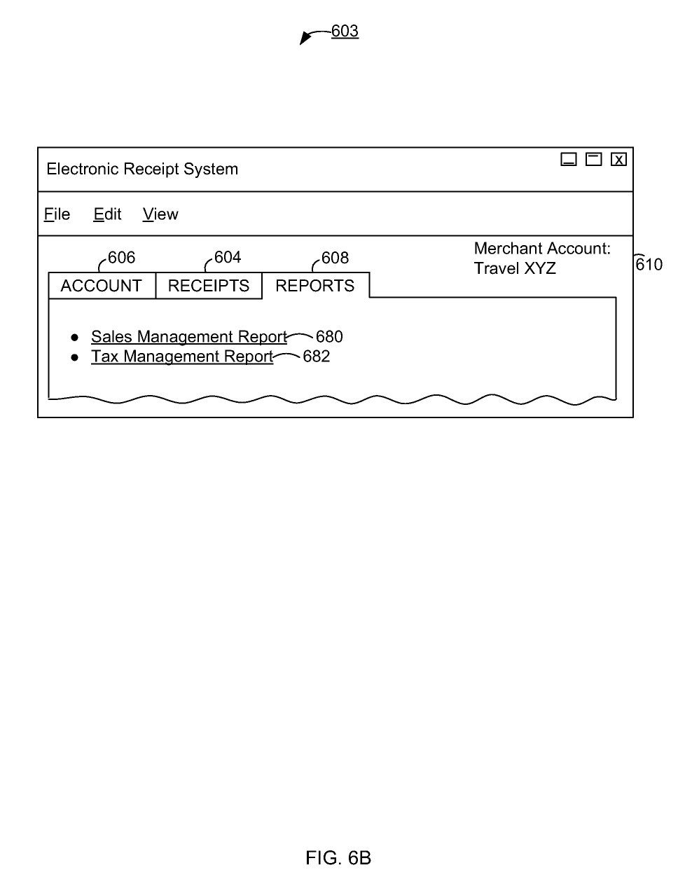

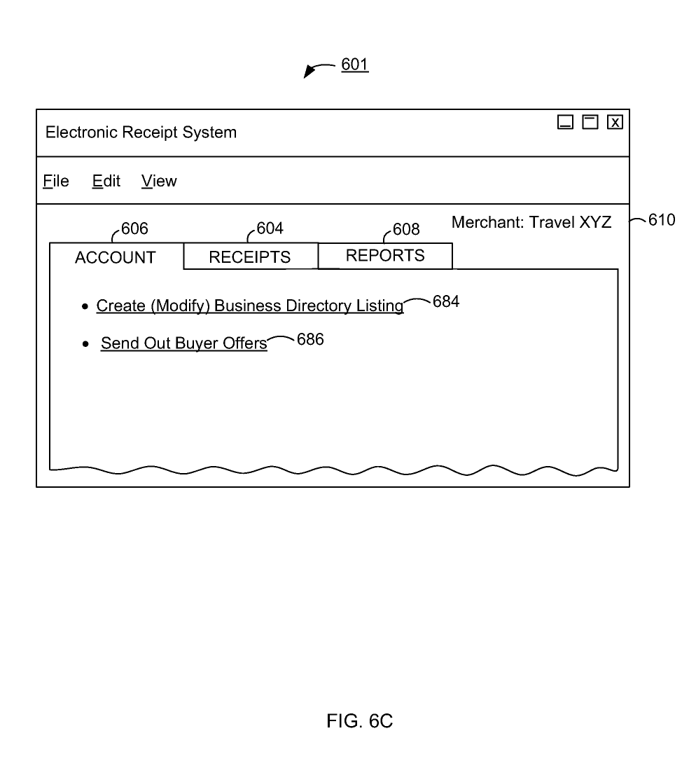

Merchant module 112 may be configured to store and access information related to a registered merchant, i.e., merchant account data. Such information may include merchant contact information, the types of product or services provided, or other suitable information for keeping track of registered merchants. Merchant module 112 may interact with hypermedia interface 122 to provide information for a merchant account environment (MPA1, described below) to computing environments 108 (example screenshots of which are provided in FIG. 6, described in detail below). To enable the functions available in merchant account environment (MPA1), merchant module 112 may also be operatively connected to electronic receipts database 118 to allow access to electronic receipts 130, and to central repository database 120 to allow access to financial transaction data 132.

Merchant module 112 may also store and provide access to information operable to provide interaction with registered buyers registered in consumer module 110 and business manager module 114. For example, this may include merchant rating information, merchant blog information, merchant promotion information and/or any other suitable information for enabling registered merchants to interact with registered buyers (A, BM). Such types of information may make reference to registered customers so as to enable a merchant to determine engaged registered buyers (A, BM) and reach out to them to access these buyer interaction tools. For example, such interaction may include sending registered customers promotions to encourage additional sales.

Merchant module 112 may also be configured to provide a business directory for cataloguing registered merchants according to various criteria. This business directory may be accessible to buyers (A, BM) or other merchants using electronic receipt system 102. Merchant module 112 may further be configured to tailor the contents of the business directory according to the user that is viewing the buyer-specific account data or the merchant-specific merchant account data that belongs to the viewer of the business directory.

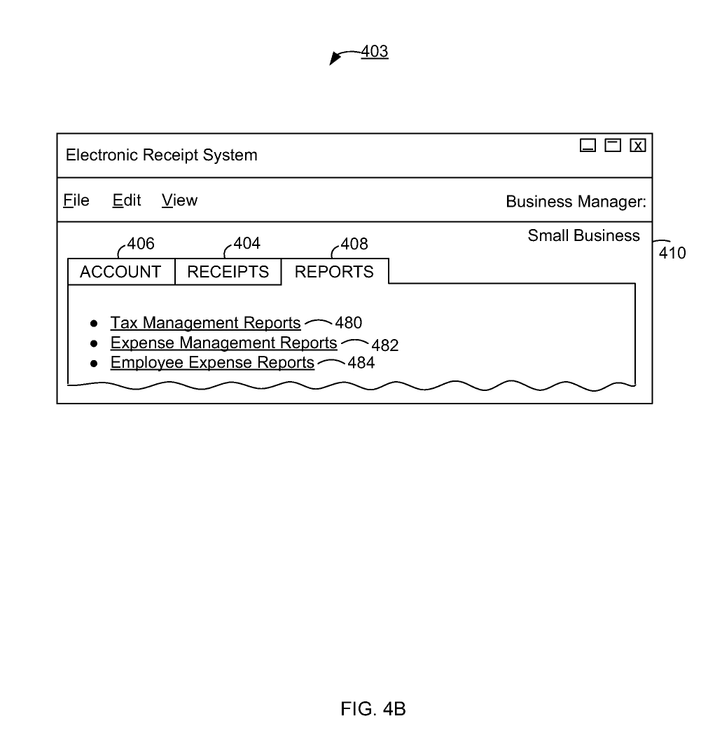

Business Manager module 114 may be configured to store and access information related to a registered business manager, i.e., business manager account data. Such information may include business manager contact information, or other suitable information for performing functions connected with operation of a business manager. Business manager module 114 may be operable to interact with hypermedia interface 122 to provide information for business manager account environments (BMPA1, described below) to computing environments 108 (example screenshots of which are provided in FIG. 4B described in detail below). To enable the functions available in business manager account environment (BMPA1), business manager module 114 may also be operatively connected to electronic receipts database 118 to allow access to electronic receipts 130, and to central repository database 120 to allow access to financial transaction data 132.

Business manager module 114 may provide functionality similar in nature to consumer module 110 because business managers may be buyers in the financial transaction that resulted in the captured financial transaction data 132 at POS terminal add-on 106. However, business manager module 114 may provide additional and further functionality catered to business managers. For example, this may include expense breakdown reports not available to customers.

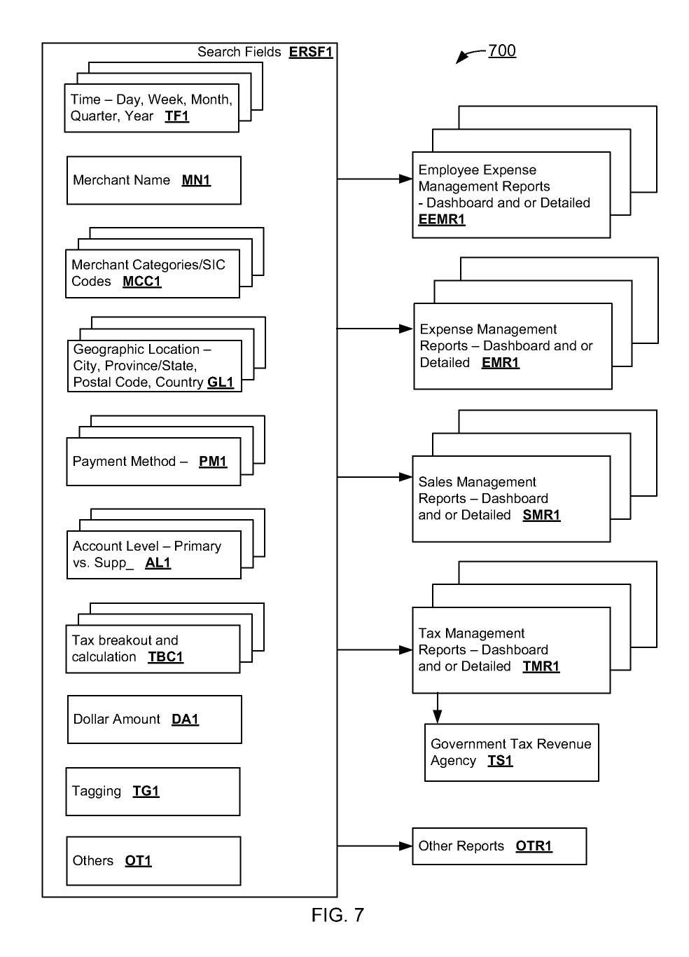

Report Module 116 may be configured to access information stored within electronic receipts 130 stored in electronic receipts database 118 to generate reports viewable in account environments 140. As noted above, electronic receipts 130 may be generated from central repository database 120. Reports may be generated using searchable fields to generate reports for display in hypermedia interfaces 122 of consumer destination account environments (CPA1), business manager destination account environments (BMPA1) or merchant business account environments (MPA1). (Example searchable fields and available reports are illustrated in FIG. 7.)

As noted above, the information stored in electronic receipts database 118 may be accessible by users using various computing platforms 108. Hypermedia interface 122 may be configured to provide access to destination accounts 140 on electronic receipt system 102. Such interfaces may be any suitable method of accessing remote information over a network 104 known in the art. For example, hypermedia interface 122 may include a website accessible by a web browser, an application programming interface (API), a web portal, a mobile website, a mobile application, and/or a smartphone application that is accessible by an installed application on computing platforms 108. Those skilled in the art will appreciate that programmatic logic for providing display functionality may be provided by hypermedia interface 122, on computing platforms 108, on a third-party display configuration server, or any combination thereof. That is, it will be appreciated that applications providing access to account environments 140 on computing platforms 108 may be thin or thick clients that perform little or substantial amounts of local processing respectively on computing platform 108. The amount of local processing on computing platforms 108 may be variable depending on concerns such as the nature of computing platform 108 (e.g., mobile communications device 108c may have limited access to processing or bandwidth resources such that it would be advantageous to reduce the amount of processing on mobile communications device 108c).

Hypermedia interface 122 may be operable to alter the appearance of destination account environments 140 according to the nature of computing platform 108. For example, a website may be adaptable to be displayed in a large format on a desktop computer 108a or laptop computer 108b, or on a mobile format (e.g., having less graphics and consuming less bandwidth) on mobile communications device 108c. Similarly, native applications on these computing platforms 108 (e.g., and without limitation, including installed applications on desktop computer 108a or notebook 108b, or mobile applications installed on a smartphone 108c (e.g., BlackBerry® or iPhone®) may likewise be adaptable to display information according to constraints of the computing platform 108 (e.g., smaller screen size and/or touch screen input).

Electronic receipts 130 may be created seamlessly in real-time directly from the POS environment add-on 106, and accessible through destination accounts 140 made available on hypermedia interface 122. As alluded to above, recipients of electronic receipts 130 may be ‘Personal Consumers’ (A), ‘Business Managers’ (BM) and ‘Merchants’ (M) of all sizes, and their respective supplementary account holders, may access electronic receipts 130 through computing platforms 108. It will be understood that ‘Business Managers’ may comprise Business Owners, Small medium Enterprises (SME's), or Corporations. Supplementary accounts associated with personal consumers may subsequently be referred to as Personal Supplementary Accountholders (SOSA2, described below), and supplementary accounts associated with business ‘Business Managers’ may subsequently be referred to as Business Supplementary Accountholders (SOSA3). Operations available to supplementary accounts will be discussed in greater detail below.

Electronic receipts 130 may contain a detailed list of transactional data and elements that are typically passed from the merchant (M) to a buyer (A, BM). The point-of-sale terminal add-on 106 of the subject embodiment will capture transactional data that is greater than Level 1 Merchant Data directly from subscribing merchants' (M) POS environments 105, during the payment process of the sales transaction. All financial transactional data 132 and electronic receipts 130 may include the financial transaction fields and may expand on further fields as the payment industry emerges. Presently in the industry, there are 3 levels of merchant data. Level 1 Merchant Data is the basic level and Level 3 Merchant Data currently contains the most detailed list of transactional information:

Level 1 data contains: Method of Payment, Card Number (of the method of payment, e.g., credit card number) & Expiry Date, Subscribing Buyer's Billing Address, Postal/Zip Code, Purchase Invoice Number, Merchant Name, Transaction Amount and Date/Time.

Level 2 data may contain the information in Level 1 data, and also: Tax Amount, Customer Code, Merchant Postal Code, Tax Identification, Merchant Minority Code and Merchant State Code

Level 3 data may contain the information in Level 2 data, and may additionally contain: Item Product Code, Item Description, Item Quantity, Item Unit of Measure, Item Extended Amount, Item Net/Gross Indicator, Item Tax Amount, Item Tax Rate, Item Tax Identifier, Item Discount Indicator, Ship from Postal Code, Freight Amount, Duty Amount, Destination Postal Code, Destination Country Code and Alternate Tax Amount.

It will be understood that captured financial transaction data may additionally or alternatively include other fields as the payment industry evolves. For example, such fields may include: Subscriber's Name and Account information; Merchant ID #; Merchant Details; Merchant Address; Merchant Telephone (and URL address where applicable); Server Name; Table # (where applicable); Check # (where applicable); POS Terminal #; Method of Payment and Expiry Date (where applicable); Name registered on method of payment; Retrieval #; Trace/Reference #; Approval #; Authorization #; Transaction amount details; Sub Total; Tax Amount (and or Alternate Tax Amount); Tip/gratuity Amount; Total Amount; Customer Code (where applicable); Tax Identification; Merchant Provincial/State Code; Item Product Code; Item/Service Description; Detailed Line Description of Items/Services Purchased; Item/Services Quantity; Item/Services Unit of Measure; Item/Services Extended Amount; Item/Service Net/Gross Indicator; Item/Service Tax Amount; Item/Service Tax Rate; Item/Service Tax Identifier; Item/Service Discount Indicator; Ship from Postal Code Freight Amount; Customs Tax and Duty Amount; Destination Postal Code; and Destination Country Code.

In some embodiments, electronic receipts 130 may be configurable to contain a variable amount of merchant level data based on the account type of the registered user (CPA1/BMPA1/MPA1/SOSA2/SOSA3). For example, an electronic receipt 130 sent to a consumer destination account environment (CPA1) may contain a basic, or reduced set of data fields that contain only the Level 1 merchant data, whereas electronic receipts 130 sent to business manager destination accounts (BMPA1) may be configured to contain merchant level data including Level 1 and 2 merchant data. Providing such tiered access to data on electronic receipts 130 may be advantageous because Business Managers (BM) may be willing to pay additional fees to access the additional data for enhanced reporting features (e.g., a tax breakdown of their expenses). Further, electronic receipts 130 sent to merchant business account environments (MPA1) may be configured to contain merchant level data including Level 1, 2 and 3 merchant data. Providing such further data may be advantageous for merchants; for example, to facilitate inventory tracking or other further enhanced reporting features.

It will be understood that while electronic receipts 130 for consumer (CPA1), business manager (BMPA1) and merchant (MPA1) accounts were discussed with respect to increasing levels of merchant level data from levels 1 to 3 respectively, any variations of data fields may be assigned to the different account types. For example, in an alternate embodiment, there may be data fields that are present for consumer accounts (CPA1), but not for business managers accounts (BMPA1); or for business managers accounts (BMPA1) that are not present for merchant accounts (MPA1). Accordingly, any embodiment where different numbers of data fields appearing on an electronic receipt 130 correspond to account types are within the contemplation of the subject embodiments.

Referring to FIG. 1B, therein illustrated are the steps of a method for generating electronic receipts, referred to generally as 101.

At step (S1), the process will begin when a buyer presents for payment at the POS terminal or environment 105. As is discussed below, payment may be in forms that require external authorization/settlement (e.g., credit card), or not (e.g., cash).

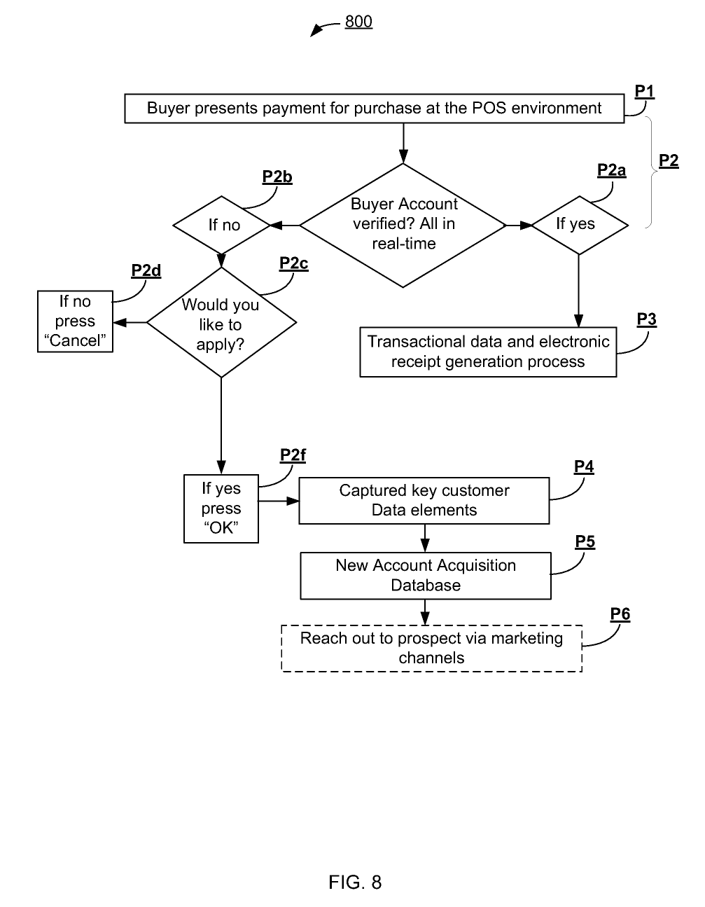

At step (S2), Account recognition module 170, which may be embedded and integrated with POS terminal 105, may seamlessly detect, capture, identify and verify the subscribing buyer's (A, BM) qualification, eligibility and destination account. Such process may occur by verifying the buyer's account information with registered accounts stored in consumer module 110 or business manager module 114. If an account cannot be determined, a new account acquisition process may be initiated (see FIG. 8, below).

At step (S3), transactional data including key data elements may be detected, identified, captured and tracked from the subscribing buyer's method of payment at the Point of Sales (POS) add-on 106; all in real-time (S5a). As mentioned above, such transaction data may be greater than Level 1 Merchant data, and may comprise various fields as indicated above. Immediately upon capturing the transactional data, the embodiment may securely transmit the transactional data (step S4) to the electronic receipt system 102. In turn, electronic receipt system 102 may store the financial transaction data 132 in a secure remote electronic data storage environment such as central repository database 120; all in real-time. Once the transactional data has been received, the information may be immediately transmitted to data processing platforms (not shown) to generate, format and prepare the presentment of electronic receipts 130 (step S5) to be stored on electronic receipts database 118; all in real-time.

Immediately upon the generation of electronic receipts 130 originating from the point of sale add-on environment 106, the subscribing buyer (A, BM) may receive notifications on hypermedia interfaces 122, which may be accessible by computer platforms 108 (step S6). Notification may take place in various formats such as in a formatted SMS text message to mobile communications device 108c (S6a), or sending of a notification message to destination account 140 indicating creation of the electronic receipt 130 (S6b).

Simultaneous with the notification(s) sent in step S6, the actual electronic receipt 130 itself may be securely sent to destination account 140 (S7), made available through hypermedia interface 122 on computing platforms 108.

In some embodiments, the electronic receipt 130 may be formatted in a barcode version such that the barcode captures the transactional information related to each purchase. Such barcode version of electronic receipt 130 may be particularly advantageous for sending to mobile device 108c. That is, to facilitate quick return or exchange of purchased goods, a buyer (A, BM) may be able to present the barcode version of an electronic receipt 130 on their mobile device 108c to a merchant (M) at a point-of-sale terminal 105. The merchant (M) may then be able to scan the barcode to process the return or exchange without manually entering in any transaction identification information, allowing the transaction to proceed in a quicker and less error-prone way. It will be understood that the barcode may be any linear, 2-dimensional or 3-dimensional barcode suitable for storing such data. In such embodiments, point-of-sale terminal add-on 106 may be provided with a suitable barcode reader/scanner to scan the barcode version of the electronic receipt 130 for reading financial transaction data associated with a transaction. In further embodiments, the barcode version of the electronic receipt 130 may not only contain the financial transaction data related to the purchase, but may additionally or alternatively contain a reference to the receipt 130 stored on electronic receipt system 102. This reference may enable additional financial transaction data 132 not captured in the barcode to be accessed at the point-of-sale environment 105 when the barcode is scanned.

As is discussed below, destination account 140 may be associated with each subscribing buyer (A, BM), and may provide the ability to access and view all (and any) of the electronic receipts 130 that has been created as a result of their purchase from a subscribing merchant (M). In one embodiment, destination account 140 may securely store each electronic receipt 130 for 10 years rolling from the time and date each receipt was created, all within the central repository database 120, allowing subscribing buyers (A, BM) to access their electronic receipts 130 any time via their online account 140.

As electronic receipts (ER1/ER2) are created in real-time and immediately followed by notifications (S6a/b/c) to the subscriber (also in real-time), the embodiments may be used as a real-time fraud detection tool. In the event that a subscriber's credit, debit and or fund accounts (A1) is/are being compromised, the subscriber may receive a trigger notification(s) that they can act on contacting their bank(s) immediately to put a freeze on their account(s). This may give the subscribing buyer a greater sense of control.

Referring briefly to FIG. 3G, therein illustrated is an example notification of the generation of an electronic receipt 130 on a mobile device 108c, shown as 302, and providing an opportunity to call the issuing bank if the indicated transaction was fraudulent.

As stated in the journey above, the described embodiments may provide for a process to be seamless to all subscribing buyers and subscribing merchants, and for the electronic receipts to be made available from the POS environments to the destination accounts 140 in real-time. That is, neither buyer nor merchant will ever have to initiate any step or act in the initial stages of engaging in each sales transaction or payment process.

Within the entire journey of a payment process where the method of payments (A1) come from the subscribing buyer's (A, BM) credit account; debit account; and (or) their funds account, neither merchant (M) and or subscribing buyer (A, BM) will ever have to implement any steps or procedures to contribute to the capture of transactional data (B3/BT3) and creation of electronic receipts (ER1/ER2). As a direct result of the embodiments, subscribing buyers (A, BM) will never ever need to keep and store their paper receipts again. Transactional data 132 may be seamlessly created in real-time (B3/BT3), directly from the subscribing merchants' (M) POS terminal device 108 and or e-Commerce platform(s) (B/BT) and transmitted (B4/BT4), to electronic receipt system 102 and stored in proprietary central repository database 120. Electronic receipt system 102 may then be operable to generate electronic receipts 130 so as to store them in destination accounts 140 and notify account holders of their creation.

Destination accounts 140 may belong to a subscribing buyer (A, BM) or merchant (M), or their associated supplementary accounts (CPA1/BMPA1/SOSA2/SOSA3/MPA1). Each account type may provide particular advantageous for each type of account holder. Account recognition module 170 may be configured to detect if the subscribing buyer is either a personal consumer (A), a business manager (BM) or supplementary accountholders (SOSA2/SOSA3). It will be understood that each subscribing account holder of a destination account 140 may be provided with a unique identifier and password. To access a destination account 140 and associated electronic receipts 130, an account holder may be required to provide this access information.

All subscribing merchants (M) may also receive copies of every electronic receipt 130 (ER1/ER2) that is created through their sales; for every electronic receipt 130 (ER1/ER2) created, one copy will go to the subscribing buyer (A, BM) and the other to them. Such receipts may be configured to be received relative to a merchant's daily sales transactions.

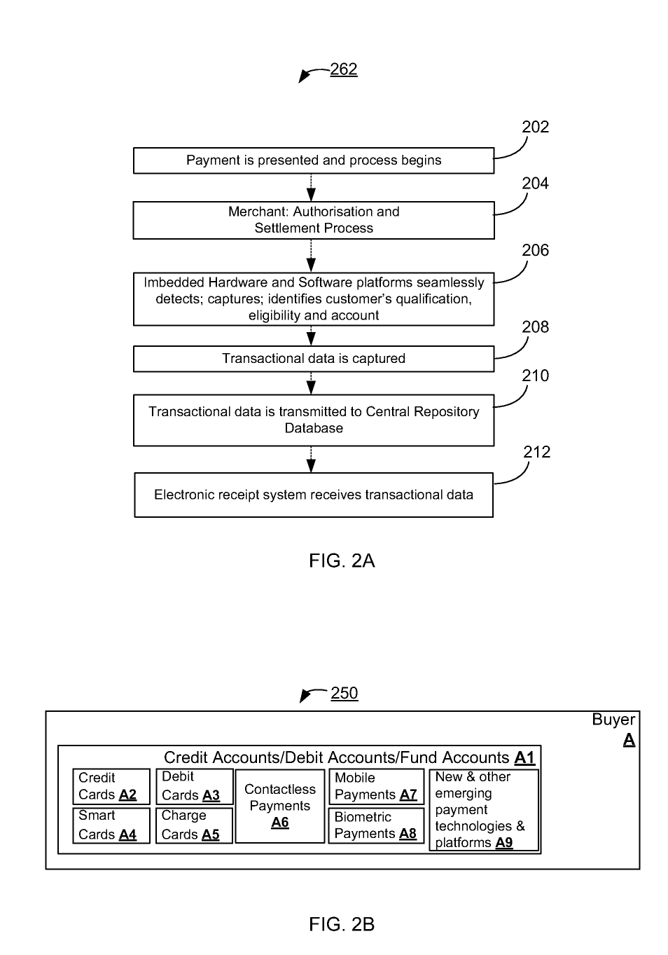

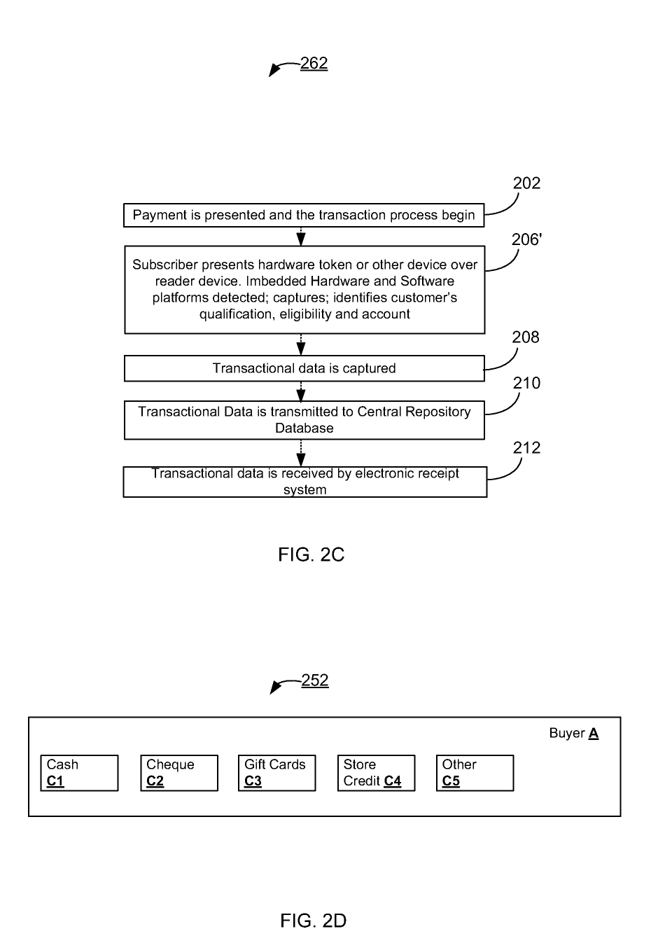

Referring to FIG. 2A, therein illustrated is a flowchart diagram illustrating the steps of capturing financial transaction information at a point-of-sale environment for payment methods requiring external authorization and settlement, shown generally as 262.

At (step 202), the seamless process will begin with an initial direct engagement of the subscribing buyer (A, BM) making and completing a sales transaction payment process with a subscribing merchant (M) at the merchant's POS environment. At (step 204), the payment method is sent to an external third party (e.g., Visa®, MasterCard® authorization and settlement process) for authorization and settlement of payment methods. If approved, step 206 provides that account recognition module 170 may seamlessly execute the detection, capture, identification and verification of the buyer's (A, BM) qualification, eligibility and destination account 140; all in real-time.

Referring briefly to FIG. 2B, therein illustrated is a block diagram of examples of such payment methods requiring external authorization, shown generally as 250. For example, such payment methods may include credit accounts (A2), debit accounts (A3), smart cards (A4), charge cards (A5), contactless payments (A6), mobile payments (A7), biometric payments (A8) or other suitable payment platforms which require external authorization, including new and emerging payment technologies and platforms (A9). In some embodiments, payment technologies may include providing a mobile application on mobile device 108c that is configured to indicate account details. In one embodiment, the mobile application may provide a bar code to represent financial account information on the smart phone or mobile device 108c. Such bar code representation may contain the financial account information normally stored in the earlier mentioned payment cards so as to remove the need of a buyer (A, BM) to separately carry such payment cards.

Also, payment technologies may include providing a mobile application on the mobile device 108c that is configured to store and indicate the buyer's (A,BM) destination account 140, which will correlate to consumer module 110 or business manager module 114. The benefit here is that the buyer (A, BM) can present the barcode to the merchant (M) to have scanned or read at the POS add-on environment 106, to ultimately create an electronic receipt 130. Once the destination account 140 has been established, subscribing buyers (A, BM) may be able to seamlessly receive electronic receipts 130 in real-time from subscribing merchants (M).

At step 208, financial transactional data 132 may be captured at the subscribing merchant's (M) POS environments 105, in real-time and securely transmitted to electronic receipt system 102 (step 210) through network 104. At step 212, electronic receipt system 102 receives financial transactional data 132 where a data processing platform (not shown) may be used to prepare, format and create the presentment of electronic receipts 130.

Neither subscribing buyers nor merchants will ever have to implement any steps, methods or procedures in a sales transactions involving an electronic bill payment that leads to funds deriving from credit account, debit account and (or) funds account. As noted, the process of creating electronic receipts 130 may be seamless within the transaction process to both the subscribing merchants (M) and subscribing buyers (A, BM), and all electronic receipts 130 may be delivered to the subscribing buyers (A, BM) and subscribing merchants (M) in real-time. To achieve seamless execution, payments being made at the subscribing merchants' (M) POS Environments 105 (linked to electronic receipt system 102) may be with funds linked back to the subscribing buyers' (A, BM) Credit Accounts, Debit Accounts and (or) Fund Accounts (A1).

When personal consumers (A) and business managers (BM) sign up for the services of receiving electronic receipts 130, they may be required to provide key data elements within their account profile to complete the account setup. These data elements will be associated to their credit account, debit account and (or) fund account(s) (A1) from where the payment and (or) funds will derive from, for the purchase of their transactions. They will also be required to provide personal information about themselves within their account profile. The account acquisition process is discussed in greater detail below.

Referring to FIG. 2C, therein illustrated is a block diagram illustrating the steps of capturing financial information at a POS terminal for payment methods not requiring external authorization and settlement, shown generally as 262. This method may be employed by buyers with accounts that may not be directly associated or connected to a subscribing buyers' credit account, debit account (and) or funds account.

At step 202, payment is presented. Referring briefly to FIG. 2D, therein illustrated is a block diagram of example payment methods that do not require external authorization and settlement, shown generally as 252. For example, such payments may include cash (C1), cheque (C2), gift card (C3), store credit (C4) or any other suitable payment method not requiring external authorization (C5). As alluded to above in relation to FIG. 2B, payment technologies may include providing a mobile application on a mobile device 108c that indicates monetary value or a denomination. In one embodiment, the mobile application may provide a bar code to represent this information on a smart phone or mobile device 108c. For payment methods not requiring external authorization and settlement, such bar codes may contain the monetary value or denomination relating to a gift card (C3) or store credit (C4) such that scanning this bar code allows for payment at the point-of-sale terminal 105.

At step 206′, buyers with accounts may use a hardware token device at the subscribing merchant's POS retail location for identifying their account 140 on electronic receipt system 102. The token device may contain their subscription identification, eligibility and destination account details. Having provided these details, financial transactional data 132 may be captured for the purposes of generating an electronic receipt 130 that is linked to an appropriate destination account 140. As discussed above, a hardware token reader attached to account recognition module 170 may read the hardware token. Such reader may include any suitable method of reading account information known in the art.

In one embodiment, the hardware token may additionally or alternatively include a hypermedia mobile application on a smartphone (e.g., mobile device 108c) that can be operable to indicate subscription identification, eligibility and destination account details. Such information may be formatted as a barcode on hypermedia mobile application. When scanned (e.g., by a barcode scanner available as a part of a point-of-sale terminal add-on 106), the barcode is operable to detect the data properties of the barcode pertaining to account information so as to identify a corresponding destination account 140.

In effect, for this embodiment, the bar code may allow the buyer to use, exercise and partake in the electronic receipt system 102 when participating in a sales transaction that does not require an external authorization process (e.g. Cash or Cheque based payments C1/C2). Such embodiment may allow a buyer (A, BM) to present the barcode to the merchant (M) to have scanned or read at the POS add-on environment add-on 106, to ultimately create an electronic receipt 130.

Any references to method of payments made with cash, cheque, gift card, store credit or others (C1-C5) may not be seamless as the subscribing buyer (A, BM) may be required to present a hardware token at the subscribing merchants' (M) POS environment, apart from their method of payment.

Having identified a destination account 140 on electronic receipt system 102 from the hardware token to associate the financial transaction data 132 and eventual electronic receipt 130, steps 208 to 212 may proceed as described above in FIG. 2A.

As the creation of electronic receipts 130 may impact 3 market segments (Consumers (A), Business Managers (BM) and Merchants (M)), the accessible capabilities of the 3 market segments are described in greater detail below.

Referring to FIG. 3A, therein illustrated is a block diagram illustrating the functionality available in a specific type of destination account 140, a consumer destination account (CPA1), shown generally as 380. Consumer destination account (CPA1) may be accessed by personal consumers (A) which may be everyday shoppers making personal consumption of goods and (or) services. CPA1 may bring new experiences to consumers, most especially in the post sales period.

For example, once generated, electronic receipts 130 may be accessed, searched, viewed, printed or downloaded (ER1). Referring to FIG. 3B, therein illustrated is an example screenshot of a consumer destination account CPA1 for consumer Angela Brown 310, shown generally as 300. The destination account environment user interface may be organized into an Account tab 306 and a Receipts tab 304 for accessing account and receipts functionality respectively. In the example embodiment, electronic receipts 130 may be organized by date. However, it will be understood by those skilled in the art that other methods of organization may also be contemplated. For example, electronic receipts 130 may be organized by merchant expense category, or amount of the expense. When consumer Angela Brown 310 clicks on a receipt 130, the electronic receipt 130 may be accessed and viewed.

Referring to FIG. 3C, therein illustrated is an example screenshot of a consumer destination account CPA1 wherein an electronic receipt 130 is viewable, shown generally as 300′. As illustrated, electronic receipt 130 shows a MasterCard® purchase made by consumer Angela Brown 310 on Dec. 29, 2008 at Travel XYZ for a flight to New York in the amount of $300.00. As discussed above, various amounts of merchant level data may be present on an electronic receipt 130 (ER1) according to the type account type of the user of electronic receipt system 102, and additional and further fields may be present on electronic receipts 130 for consumer accounts as well as business manager accounts and merchant accounts.

In addition to viewing electronic receipts 130, consumer destination account (CPA1) may provide consumer Angela Brown 310 the ability to perform further functions related to electronic receipts 130. For example, user interface for consumer destination account CPA1 may have buttons and other functionalities providing the ability to print 332, download 334 or see further details 330 concerning the electronic receipt 130. As will be understood, these functions may be provided in the form of buttons on the user interface or any other suitable mechanism of accessing operations on computing platforms 108 known in the art.

Referring to FIG. 3D, therein illustrated is an example screenshot of account-level functionality available in consumer destination account (CPA1), shown generally as 301. In the example embodiment, Consumer Angela Brown 310 may access such functionality under the Account tab 306. As noted above, Angela Brown may be able to access operations related to creating spend alerts 352, creating supplementary accounts 354, reviewing merchant offers 356, viewing a business directory 358 or viewing comments on a merchant blog 360.

Also, subscribing account holders may be able to create alerts that will be triggered by subscriber-determined fields and parameters. For example, spend alerts (SA1) may be generated so that a consumer is notified if a spending threshold has been exceeded. Such ‘Spend Alerts’ (SA1) on either their own overall account (CPA1) and or on each supplementary account (SOSA2) (described below), allowing notifications (S6a/b/c) to be sent in real-time once spend thresholds have been reached. The spend thresholds may be determined by the personal consumer (A). For example, spend alerts (SA1) may be set by: Calendar time; merchant name; merchant category; geographic location; expense amount; method of payment; by overall spend threshold amounts at the primary account level, by spend threshold amounts on overall supplementary accounts (SOSA2).

Referring to FIG. 3E, therein illustrated is an example screenshot of a consumer destination account (CPA1) providing the Spend Alert (SA1) ability to consumers (A), shown generally as 301′. In the example user interface, consumer (A) is provided with the ability to choose which payment method to receive Spend Alerts 370 for (Visa® card). Also, they may be provided with notification options for where to receive such notifications 372, 376 and the ability to configure spending thresholds 374 and geographical locations 378 for when the alerts should trigger. In the example user interface, consumer Angela Brown 310 has selected to be notified via SMS when purchases are above $500, and if purchases are made outside of Canada.

It will be understood that thresholds or other events in relation to subscriber-determined fields and parameters may also trigger alerts. For example, these fields may be any one or combination of number of fields captured in financial transaction data 132. Examples of various fields for which alerts may be triggered are illustrated in FIG. 7.

Further, consumer destination account (CPA1) may access stored data on consumer module 110 and merchant module 112 to provide information about merchants (M). For example, referring again to FIGS. 3D and 3A, consumer destination account (CPA1) may be configured to allow consumers to receive merchant offers 356 (MO1), view a business directory 358 (B2BD1) or view comments on merchant blogs 360 (MV1). After viewing such information about merchants, consumer destination account (CPA1) may be configured to allow a consumer to manipulate such information. For example, consumers may be allowed to trade merchant offers (TMO1), create a custom directory (B2BD2), or add/share comments on merchant blogs (AMV1).

With regard to receiving merchant offers, consumer module 110 may be configured to allow subscribing merchants (M) to create target profile marketing campaigns to target subscribing consumers (A) with incentive discounted offers, enticing them to return back for more business. Targeted subscribing personal consumers (A) and supplementary accountholders (SOSA2) may receive notifications (S6a-c) informing them of a newly arrived offer (MO1).

Consumers may then trade/exchange/swap their received merchant discount offers with other account holders (TMO1). Such functionality may be provided via an account holder's destination account 140 and hypermedia interfaces 122.

Referring to FIG. 3F, therein illustrated is an example user interface for consumer (A) to trade merchant offers 390, shown generally as 301″. When consumer (A) clicks on a link to Review Merchant Offers 356, offers 390 may appear on this screen such that a consumer (A) may be presented with the option to Redeem 392 or Offer for Trade 394 the offer. In the exemplary user interface, consumer Angela Brown 310 is presented with two merchant offers: a 10% discount off a flight from TravelXYZ, which she may redeem 392 or trade 394; and a free weekend car rental from ABC Car Rental, which she may also redeem 392′ or trade 394′.

With regards to a business directory (B2BD1), consumers (A) (and supplementary accountholders (SOSA2), as discussed below) may be able to view a business directory list of subscribing merchants (B2BD1), and also build a custom business directory list (B2BD2) of subscribing merchants (M) that they've recently or normally shop at (not shown). This list may be created and made available to access on their destination account 140 (CPA1/SOSA2). The business directory (B2BD1) may also offer some alternative merchant recommendations along with virtual mapping capabilities via the hypermedia interfaces 122.

With regards to merchant blogs (AMV1), consumers (A) may be able to post textual comments. ratings or opinions on a shared/common area on the website, about their most recent visit and experience at a subscribing merchant (M). Such comments may be seen by fellow subscribing customers (A, BM) all via the company website and their hypermedia interfaces 122.

Moreover, in alternate embodiments, consumers (A) (and supplementary accountholders (SOSA2), as discussed below) may be able to view static expense reports (ER1) covering set calendar cycles (not shown).

Referring to FIG. 3G, therein illustrated is an example user interface on mobile computing device 108c indicating a notification (S6a) of the generation of an electronic receipt 130, shown generally as 302. As noted earlier, such notification may contain the contact information of the issuing bank 398 so as to provide immediate notification of a purchase such that a buyer (A, BM) may contact the issuing bank to put a hold on funds if the transaction is fraudulent. It will be understood that mobile device 108c may also be operable to notify consumer (A) in other mechanisms besides SMS, such as mobile e-mail, or other immediate mobile notification mechanisms.

If in the event a consumer (A) or supplementary accountholders (SOSA2) has become dissatisfied with the product or service rendered to them, they may simply access the respective electronic receipt 130 (ER1) related to that product or service, print it and return back to the store to exercise the merchant's Customer Return Policy. Additionally or alternatively, as indicated above, if they have opted to receive electronic receipts (130) formatted as a barcode on their mobile smartphone device (108c) then they can return back to the store and have the merchant (M) scan their electronic receipt (130) to facilitate the exchange or return.

The embodiments may also enable personal consumers (A) and supplementary accountholders (SOSA2) to create other (OT1) new features and capabilities.

Furthermore, consumer destination account (CPA1) may allow the creation of supplementary accounts (SOSA1) who may also receive notifications when electronic receipts 130 have been generated (SOSA2) (described in greater detail below).

It will be understood that the user interface shown is provided for illustration purposes, and that access to the described functionality may be implemented using other suitable methods of organizing access to computer-implemented functionality known in the art. For example, in alternate embodiments, the provision of a business directory may be made available on the subscribing customers' home account page so as to allow merchants to have greater access to consumers. Such embodiment may be designed for merchants to sign-up and benefit from the listing.

Referring to FIG. 4A, therein illustrated is a block diagram illustrating the functionality available in a business manager destination account, shown generally as 480.

Business Managers destination accounts (BMPA1) may be used by business operators to better manage and understand their expenses. For example, as noted above, business manager accounts may be owned by Business Owners, Small & Medium Enterprises (SME's), or Corporations. The described embodiments may be advantageous for Business Managers by creating new POS, post sales, new business expense management experience and allow for significant cost savings and ROI's.

The functionality described below may be provided by Business Manager Module 114, which offers its operations to business managers (BM) through hypermedia interface 122, accessible by computing platforms 108. As is the case for consumer destination account (CPA1), business manager module 114 may interact with merchant module 112, where appropriate (e.g., customized business directories), to access information relating to merchants (M). Also, it may access reports module 116 for providing various reports to business managers (BM).

Business manager account BMPA1 may provide operations that are similar to those provided in Consumer Destination Accounts (CPA1). For example, electronic receipts 130 may also be configured to Create Spend Alerts (SA1), Create Supplementary Accounts (SOSA1), Receive Merchant Offers (MO1), View Business Directory (B2BD1), or View Comments on merchant blogs (MV1). However, the operations may be specifically configured to be advantageous for business managers.

For example, the ability of business managers to safely access their company expensed related receipts any time through their accounts 140 may mitigate any risk of losing paper receipts. Such ease of access may be particularly advantageous for businesses in the event that the business is being audited for business and (or) tax purposes.

Also, in relation to setting up ‘Spend Alerts’ (SA1), business managers (BM) may allow notifications (S6a/b/c) to be sent in real-time once spend thresholds have been reached (see e.g., the analogous case for consumers (A) in FIG. 3E). The spend thresholds may be determined by each business manager (BM). For business managers (BM) who also act as employers, ‘spent alerts’ may be created for supplementary (employee) accounts. Such spend alerts may be provide a particularly advantageous way to monitor employee expenditures, and may be set according to similar criteria as was discussed with respect to consumer destination accounts (CPA1).

Furthermore, similar to consumer destination accounts (CPA1) the embodiments may facilitate the means of allowing all accountholders (BMPA1/SOSA3) to view a business directory (B2BD1), and to build a customizable business directory list of subscribing merchants (B2BD2) that they've recently or normally shop at. Such embodiments may include the creation of an online business to business directory listings and business to consumer directory listing. As with consumer destination accounts (CPA1), Business Managers may also trade their recently received offers with other subscribing buyers (A, BM).

In addition to functionality already available in consumer destination account environments (CPA1), business manager destination account (BMPA1) may additionally be configured to provide further features for assisting business owner (BM). This may include the creation of tax management reporting capabilities (TMR1), where subscribing buyers and subscribing merchants (discussed below) may identify their respective tax calculations pertaining to their good and (or) services they either purchased or sold. As noted earlier, since electronic receipts 130 may be safely stored in the remote central repository database 120, and made accessible for up to 10 years rolling; business managers, business owners, companies (and merchants, discussed below) may access their electronic receipts 130 so that they can prepare for a business and (or) tax audit.

The embodiments may further allow subscribing companies to perform faster and accurate tax reconciliation reports, as each transactional data will capture detailed tax amounts and breakouts. Through the creation of the tax management reports (TMR1), Business managers and supplementary accountholders (BM/SOSA3) may be able to have their tax amounts identified from each electronic receipt 130, populated and then have a total tax amount determined for any criteria of time. The embodiments may allow business managers (BM) to directly submit these tax amounts and dues to the Government Tax Revenue Agency (TS1, see FIG. 7), from their destination accounts.

In one embodiment, such reports may provide expense management reporting capabilities (EMR1), where subscribing business managers may view both dashboard level expenses and conduct detailed dynamic reports and searches on electronic receipts under their account structure. As is discussed below, employees who have been assigned a supplementary account can create and submit employee expense reports (EEMR1) on their business related expenses, as well as conduct dynamic searches only with their own supplementary account.

Such reports may be configured to be customized ‘hierarchal’ reports—Expense and Tax (EMR1/TMR1)—allowing Business Managers (BM) to get a very clear overview of their entire company related business expenses and taxation accounts.

Referring to FIG. 4B, therein illustrated is an example screenshot of a business manager destination account (BMPA1) on hypermedia interface 122 viewable on computer platforms 108, shown generally as 403. Similar to consumer destination account (CPA1), business manager destination account (BMPA1) may be provided with a Receipts tab 404 providing the ability to access, print, download or view the details of an electronic receipt 130 (as is similarly illustrated for consumer destination account CPA1 in FIG. 3C). Also, business manager destination account (BMPA1) may also be provided with an Account tab 406 for providing access to functionality related to a business manager accounts (as is similarly illustrated for consumer destination account CPA1 in FIG. 3D). Additionally, business manager destination account (BMPA1) may be further provided with a ‘Reports’ tab 408 that provides access to reports made available to business manager destination accounts (BMPA1). For example, business manager of a business called ‘Small Business’ 410 may be able to click on and access ‘Tax Management Reports’ 480, Expense Management Reports 482, or Employee Expense Reports 484.

As noted above, reports required by various destination account types 140 may be generated by reports module 116, which is able to search and analyze financial transaction data 132 stored on central repository database 120, and electronic receipts 130 stored on electronic receipts database 118.

The embodiments may also allow business managers (BM) and supplementary accountholders (SOSA3) to create any formatted report generations (OTR1) they so desire by using search fields (ERSF1), all via their destination accounts which can be accessed through their hypermedia interfaces 122.

Referring briefly to FIG. 7, therein illustrated are available searchable fields and the associated available reports that may be generated from reports module 116, shown generally as 700. Reports may be created by using one or a combination of the illustrated searchable fields (ERSF1): Time (TF1); Merchant name (MN1); Merchant category/SIC Code (MCC1); Geographic location (GL1); Payment method (PM1); Account level (AL1); Tax Breakout and calculations (TBC1); Dollar amount (DA1); Tagging (TG1) and Other (OT1). Reports (EMR1/TMR1) may be able to provide great detailed search results, as well as provide a graphic illustrated dashboard overview. These reports (EMR1/TMR1) may be printed, sent as an attachment and or downloaded to the desktop or a computer device 108.

The embodiments may allow primary and secondary accountholders, discussed below (BMPA1/SOSA3) to view blogs and post their ratings and opinions on a dedicated area on company website (MV1/AMV1), so that they can share their most recent experience at a subscribing merchant. This may be seen by fellow subscribing business managers and supplementary accountholders (BMPA1/SOSA3) via hypermedia interfaces 122 viewable on computing platforms 108.

The embodiments may also enable business managers (A) and supplementary accountholders (SOSA3) to create other (OT1) new features and capabilities.

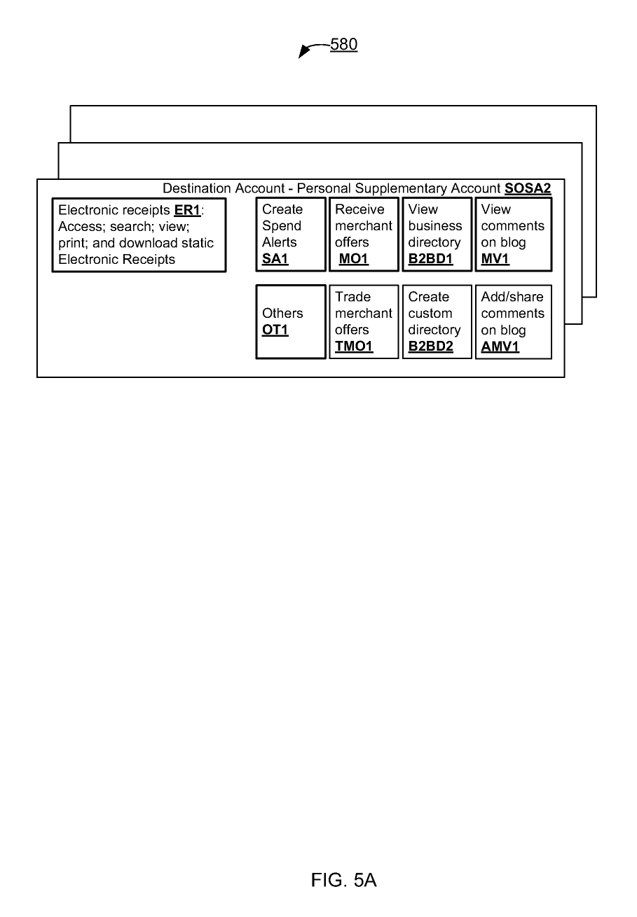

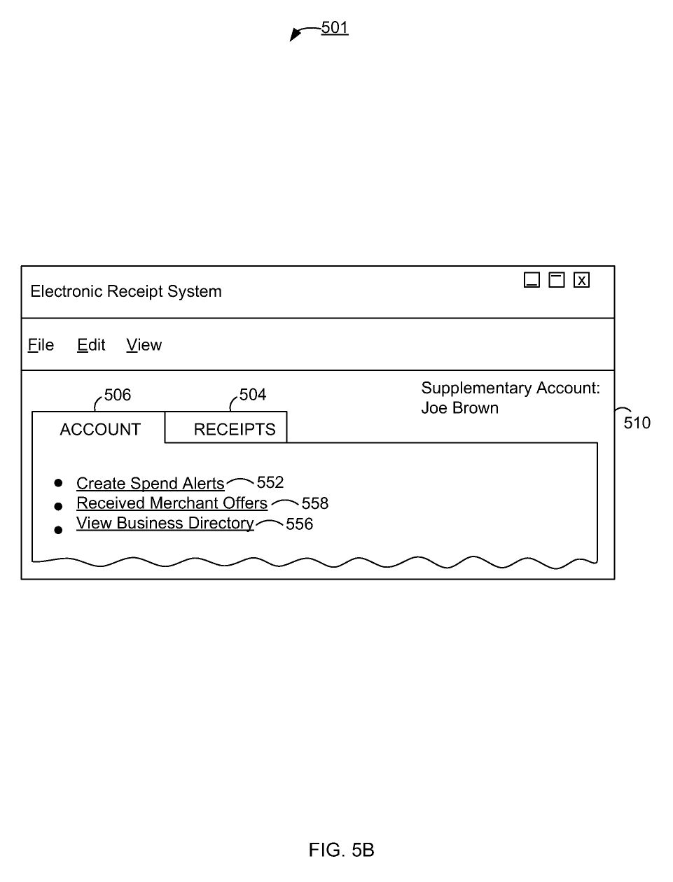

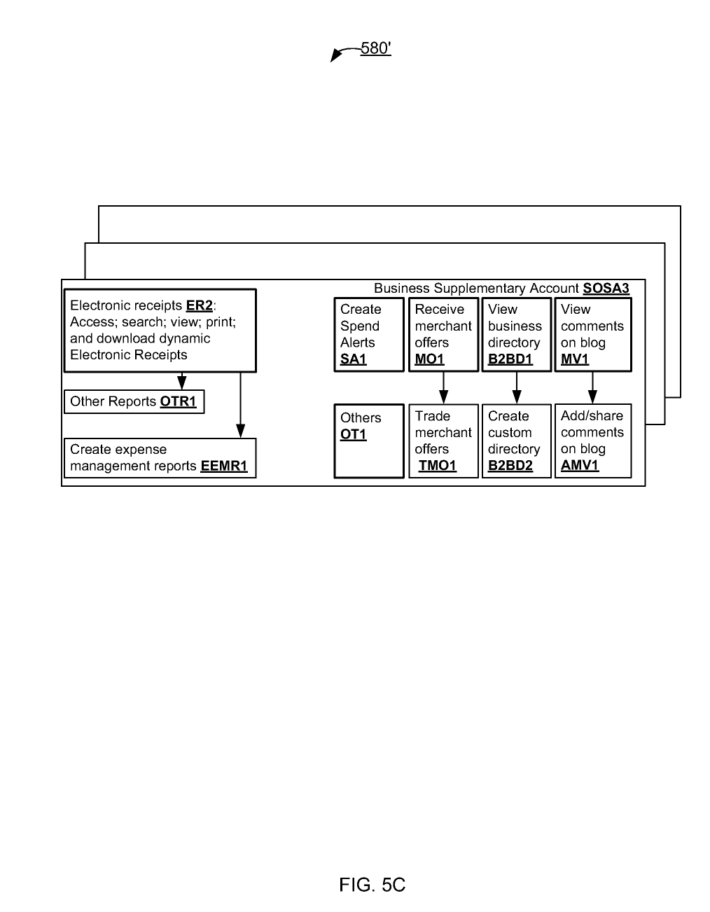

Referring to FIGS. 5A and 5C, therein illustrated are the functionality available to personal and business supplementary accounts, shown generally as 580 and 580′ respectively. As noted above, both consumer destination account (CPA1) and business manager destination account (BMPA1) may provide the capability of creating supplementary accounts. Consumers (CPA1) or Business Manager Destination Account (BMPA1) may be able to create supplementary accounts (SOSA1) under their primary account. As each supplementary accountholder (SOSA2/SOSA3) creates electronic receipts 130 (ER1/ER2), they will be sent to the remote electronic platforms and (or) devices and registered under the primary account (the grandfather account) and made accessible to both the primary (CPA1/BMPA1) and supplementary accountholders (SOSA2/SOSA3). The primary account (CPA1) will always remain the hierarchal account and controller (the grandfather account).

Each time supplementary accountholders (SOSA2/SOSA3) create electronic receipts 130 (ER1/ER2) they are sent to the primary and supplementary accountholders (BMPA1/SOSA3). Simultaneously to the aforementioned, both levels of accounts will receive real-time notifications (S6a-c) informing them that an electronic receipt (ER1/ER2) has been generated via their registered method of payment(s) (A1) and that is immediately available to access. The primary account will be the ‘grandfather account’ and subsequently will receive notifications (S6a-c) for each generation of electronic receipt 130. These notifications may be delivered through hypermedia interface 122 channels earlier described. Notifications (S6a-c) to both the primary and supplementary accounts may create immediate and transparency and accountability between the employee and the employer (and the company).

For example, subscribing buyers (A, BM) and supplementary accountholders may opt to receive additional versions of their electronic receipts 130 via their cellular or smart phone SMS text channel; all in real-time.

It will be understood that when a supplementary account holder (SOSA2/SOSA3) executes a financial transaction, the primary account holder (A, BM) may not be present at the geographical location where the financial transaction is taking place. As such, the notification may be sent to at least one destination account that belongs to a person not present at the physical location of the financial transaction.

Supplementary account holders may have access to some functions available to their respective primary account holder (A, BM). For example, FIGS. 5A and 5C illustrates such functionality may include accessing, searching, viewing, printing, or downloading static electronic receipts 130 (ER1/ER2). Also, it may also include creating spend alerts SA1, receiving merchant offers MO1, viewing business directory B2BD1 or viewing comments on a merchant blog MV1.

As described above, the creation of spend alerts SA1 informs subscribing customers that their spend threshold limit has been reached. Notifications would be sent out immediately once the alert has been triggered. The spend alerts will be created using multiple fields by subscribing account holders.

Referring to FIG. 5B, therein illustrated is an example screenshot of a personal supplementary account SOSA2 for personal supplementary account holder Joe Brown 510, shown generally as 501. Similar to the operations available for primary consumer destination account for Angela Brown 310 (FIG. 3D), functionality may be placed in an Account tab 506 and a Receipts tab 504. While electronic receipts 130 may be viewable under Receipts tab 504, the Account tab 506 is illustrated as providing a reduced feature set, including only the ability to create spend alerts 552, receive merchant offers 556 and view a business directory 558.

Referring to FIG. 5C, therein illustrated is a block diagram for illustrating the operations available in business supplementary account SOSA3, shown generally as 580′. As noted above, a supplementary business account SOSA3 may be provided to an employee in a business where the employer holds a business manager destination account BMPA1. It may be particularly advantageous for employees to store electronic receipts 130 such that the subsequent creation of employee expense management reports EEMR1 is facilitated. The ability to create such reports for supplementary business accountholders removes the need of collecting and submitting paper receipts. The embodiments thus may reduce time for creating and submitting these reports and provide more opportunity to allow employees to be highly productive, while saving on administrative costs.

As alluded to earlier, along with destination accounts 140 for buyers, destination accounts 140 may also be available for subscribing merchants (M) such that subscribing merchants (M) may eventually never ever have to issue paper based receipts. Electronic receipt system 102 comprising computer-related embodiments with software and hardware platforms may capture transactional data 132 each time a sales transaction takes place. Such financial transaction data 132 may then immediately transmitted to central repository database 120, with electronic receipts 130 being ultimately generated and stored in destination accounts 140 (CPA1/BMPA1/SOSA2/SOSA3/MPA1). Simultaneous with the delivery of notification and/or electronic receipts 130 to subscribing buyers (A, BM), all subscribing merchants (M) may also receive copies of every electronic receipt 130 (ER1/ER2) that is created through their sales; that is, for every electronic receipt 130 (ER1/ER2) created, one copy will go to the subscribing buyer (A, BM) and the other to them.

Referring to FIG. 6A, therein illustrated is a block diagram illustrating the functionality available in a merchant destination account, shown generally as 680. Each subscribing merchant (M) may receive a destination account 140 (MPA1), where they can access, search, view, print and download all (and any) of the electronic receipts (ER1/ER2) that has been created as a result of their sales. Such functionality may provide particular advantage for subscribing Merchants (M) by creating new POS, post sales and merchant (M) experience, as well as allow for cost savings and ROI's.

Since the embodiments may securely store each electronic receipt 130 for 10 (ten) years rolling as each receipt is being created, these receipts 130 may be securely stored within the central repository database 120. This means merchants (M) will never have to deal with physical administrative management of paper based receipts or absorb costs associated with storing actual sales receipts/slips.

Also, depending on the scale of the merchant (M), they may likely have to physically reconcile and calculate daily sales generated by payment type (see e.g., A1-A9 in FIG. 2B and C1-C4 in FIG. 2D), and this involves them separating and calculating sales generated by each plastic payment card type (e.g.—Amex, Discover Card, Diners Club, JCB Cards, MasterCard® and Visa®). Electronic receipt system 102 may enable subscribing merchants (M) to effectively manage their daily sales reconciliations, by allowing them to create sales management and reconciliation reports (SMR1). Through these daily-generated reports, sales reconciliations will be automatically reconciled and calculated by all payment method type. Merchants (M) may be able to spend more time and effort on their business sales and less time and costs on the administration.

Through the electronic receipt system 102, subscribing merchants (M) may significantly save on costs for not ever having to pay for printer supplies (printer rolls and ink cartridges), as the inventions may eventually replace paper receipts and the means of producing them.

Moreover, the embodiments may simplify and streamline the process of addressing chargeback disputes, as electronic receipts will be easily identified, tracked and electronically transmitted to the Acquiring Bank, versus enduring the current paper trail and postage system, which is very time consuming. Merchants (M) may be able to reconcile their sales quicker and inexpensively by addressing the charge in question through accessing and quickly identifying the electronic receipt (ER1/ER2) via their destination account 140.

Since Merchants (M) may have similar concerns as Business Managers (BM), many of the benefits of electronic receipt system 102 discussed in that context may be applicable for Merchants (M) also. For example, since businesses are required to keep receipts and other sales related documents for 7 years rolling, in the case of having a business/tax audit, the embodiments may keep and securely store the merchants' sales (electronic receipts 130) for this duration. Subscribing merchants (M) may be able to access this data on their destination account 140 (MPA1) at any time.

Additionally, merchant destination account (MPA1) may provide features that are particularly advantageous for merchants.

For example, as noted, merchants may be able to create sales management reports (SMR1). Such reports aim to help subscribing merchants effectively and efficiently conduct their daily card sales reconciliations—allowing them to allocate more time to their business and reduce administrative costs, and to also allow merchants to effectively and efficiently conduct an inventory reconciliation of their business stocks and supplies.

Also, through electronic receipt system 102, subscribing merchants (M) may be able to separate and calculate tax amounts that they owe to the Government Tax Revenue Agencies on the products and services they've sold. Merchants (M) may be able to create tax management reports (TMR1), which will automatically calculate tax breakouts and amounts of their sales. The embodiments may also allow merchants (M) to submit these tax amounts and dues directly to the Government Tax Revenue Agency.

Referring briefly to FIG. 6B, therein illustrated is an example screenshot of a merchant destination account MPA1 for a merchant providing travel agency services, TravelXYZ 610, shown generally as 603. Similar to buyers' (consumer and business managers) destination accounts 140 (CPA1/BMPA1), there may be a Receipts tab 604 and an Account tab 606 for providing analogous functionality. Under Reports tab 608, therein illustrated are links to access to a sales management report 680 and a tax management report 682. It will be understood that other and further reports may be provided.

The embodiments may also allow subscribing merchants (M) to create any formatted report generations (OTR1) they so desire by using search fields (see e.g., ERSF1, in FIG. 7), all via their destination accounts which can be accessed through their hypermedia interfaces 122.

Referring to FIG. 6C, therein illustrated is an additional example screenshot of the features available in merchant destination account (MPA1). Such features may assist in the creation of spend centric programs, where the embodiments may allow subscribing merchants to request for participation in the target profile marketing initiatives and campaigns (merchant discount offers), to ultimately create stronger traction for customer loyalty and higher sales revenues. Such offers may be derived by conducting data analysis of collected financial transactional data 132 stored on central repository database 120, to create and develop electronic and non-electronic offers. The offers may be communicated to potential customers through channels similar to how electronic receipts 130 are sent to registered users (A, BM, M) (see e.g., step S6 in FIG. 1B).

For example, subscribing merchants (M) may be able to be featured on the company's online business directory (B2BD1), in consumer destination account (CPA1) and business manager destination account (BMPA1). The online business directory will be available to all subscribing buyers (CPA1/BMPA1/SOSA2/SOSA3) to view and will only feature the subscribing merchants' (M) contact details, such as name, address, telephone number(s), fax number(s) and Internet address. Furthermore the online business directory may categorize the listings by merchant categories, geographic locations, and may also provide mapping capabilities for listed merchants (M). In one example embodiment, such business directory listing may be created or modified on the Account tab 606 of the user interface, wherein the functionality to create or modify the business directory listing 684 is provided.

The embodiments may allow and create environments and platforms where subscribing merchants (M) can create target profile marketing initiatives to target specific subscribing buyers (A, BM), and their associated supplementary accounts (SOSA2/SOSA3) with incented discounted offers (MO1). These offers may be sent to buyers (A, BM) through the proprietary notification channels (S6a/b/c in FIG. 1B), as well as their destination account (CPA1/BMPA1/SOSA2/SOSA3). In one example embodiment, such offers may be created on the Account tab 606 of the user interface, wherein the functionality to sent out offers to potential buyers (A, BM) 684 is provided.

In an alternate embodiment, the merchant (M) may send in a message to the electronic receipt system 102 requesting a target list of profiled customers of their desired targeted audience. As noted, the electronic receipt system 102 may be operable to conduct a data mining analysis of collected financial transaction data 132 stored in the central repository database 120. Electronic receipt system 102 may also request that the merchant (M) submit their marketing creative campaign. The electronic receipt system 102 would then identify the list of target profiled customers and execute the distribution of the marketing creative campaign through the channels as outlined in S6a/b/c of FIG. 1B.

The sending of offers to potential buyers (A, BM) and their supplementary account holders (SOSA2/SOSA3) may be performed using channels used to notify subscribing buyers of the generation of electronic receipts 130 in their destination accounts 140. As discussed above, these channels may include, but are not limited to sending: a message posted to the destination account; an email sent to their personal email inbox; and (or) via SMS text messaging (if they've opted for this feature). If a subscribing buyer (A, BM) has been targeted by subscribing merchants with target profile marketing initiatives, the potential buyer may accept offers through these channels.

Furthermore, through merchant module 112 may provide a dedicated space on hypermedia interface 122 for enabling all subscribers to view, share and add blogging posts of fellow subscribers' shopping experiences/comments/recommendations and ideas as they relate to a given Merchant (for primary and supplementary account holders in the case of personal consumers (A) or business managers (BM)).

Having discussed various aspects of the operation of electronic receipt system 102, discussion now moves to initial setup that may be required to allow electronic receipt system 102 to operate.

During the account setup stage, subscribing merchants (M) may be able to download, integrate and install the point-of-sale terminal add-on 106 within their Point of Sale (POS) environments 105, for both physical retail locations and all e-commerce environments. As described above, once installed, the point-of-sale terminal add-on 106 may be operable to capture financial transaction data 132 for generating electronic receipts 130.

Before electronic receipt system 102 may be used by buyers (A, BM) to receive electronic receipts 130 from merchants (M), each may need to create an online destination account 140 on electronic receipt system 102. During the account creation process, account holders may need to provide a unique identifier and password for their destination account so as to be securely access their receipts.

When creating accounts, buyers (A, BM) and merchants (M) may be required to provide personal background information and additional pre-determined key data elements that may allow for payment of funds via payment methods that require external authorization. Such account creation may occur through Internet websites provided by electronic receipt system 102, or immediately at the POS terminal 105 for a non-subscribing buyer. The latter scenario may arise if a non-subscribing buyer makes a purchase at electronic receipt system 102.

Referring to FIG. 8, therein illustrated is a flowchart diagram illustrating the steps of acquiring a new registered buyer at the POS terminal 105, shown generally as 800.

At P1, a buyer presents payment for purchase at the POS environment. At P2, account recognition module 170 (as shown in FIG. 1A) attempts to determine if there the buyer (A, BM) is associated with a destination account 140. If account recognition module 170 (which may comprise computer-related embodiments—comprising of software and hardware platforms, as earlier discussed) recognizes a destination account 140 (P2a), the transactional data and electronic receipt 130 generation process proceeds as per described in S3-S7 of FIG. 1B, i.e., continuing in a ‘business as usual’ fashion, by seamlessly capturing transactional data in real-time and following the processes to ultimately deliver electronic receipts 130 to the destination accounts 140 (P3).

If, however, account recognition module 170 (as shown in FIG. 1A) does not recognize the subscribing buyer (A, BM) as being associated with a destination account 140, it may automatically assume the buyer is a non-subscriber.

That is, if the account recognition module 170 (as shown in FIG. 1A), detects that the buyer is not a subscriber (P2b), it will begin the process of asking if the prospect would like to apply (P2c). If the prospect provides a response claiming “No” (P2d), then POS terminal add-on 106 would allow the financial transaction to take place without the capturing of financial transactional data 132 and generation of electronic receipt 130 by electronic receipt system 102.

If the prospect provides a response claiming “Yes” (P2f), then the computer-related inventions—comprising of software and hardware platforms—would lead to capturing key data elements from the prospect's key customer data elements, typically including payment information details (P4). Upon capturing, the data will then be transmitted to a secure new account acquisition database (not shown) (P5), in real-time. The information in the database may be optionally used to reach out to the prospects to guide them in completing their account setup (P6).

Since the invention may identify non-subscribing buyers at the subscribing merchants' POS location(s) 105, this may drive the opportunity of growing new acquisition of subscribing buyers to electronic receipt system 102, directly from the frontline. Whenever the account recognition module 170 (as shown in FIG. 1A) does not identify a subscriber, it may automatically assume that the person is a non-subscriber and will prompt the person through a message via the POS terminal 105 or via the e-Commerce platforms if they would like to receive electronic receipts 130. If the prospect would like to begin receiving electronic receipts, they will follow some basic steps directed on the POS environment/platform 105 to show acknowledgment and to provide their consent in allowing the invention to collect some key data elements from their method of payment/EBPP (Electronic Bill Presentment and Payment). By retrieving their data elements the invention may engage in steps to create and set-up an account for the new subscribing buyer (A, BM).

To better illustrate the operation of electronic receipt system 102, the following is an example of a potential use of such system. As the computer-related embodiments may be able to serve 3 market segments, the following will be an example of a Business Manager:

A small business owner (BM), who has 3 employees, is subscribing to receive electronic receipts 130 for the business expenses that go against his company. Through the subscription, he has an online account 140 and has created 3 supplementary accounts (SOSA3), one each for his employees. At the time of creating the account, he and his 3 employees were prompted to provide key data elements pertaining to their payment cards, in order to complete the account setup. The key data elements are important as it identifies who they are, their qualification, eligibility and their account for seamlessly receiving electronic receipts, in real-time. At the time of the account set-up, they all opted to receive SMS text notifications and additional electronic receipts via their smart phones.

The business owner buys some products from an office supplies merchant who also is a subscriber to electronic receipts system 102. At the checkout 105, the business owner (BM) follows the normal procedures to complete the transaction using his business smart card. He inserts his business smart card in to the smart POS add-on 106 and enters his PIN to proceed with the payment process. Once the payment has been authorized and completed, the business owner (BM) then withdraws this business smart card from the smart POS terminal device, collects his purchased items and leaves. During this transaction process, no paper receipt was issued from the merchant to the business owner (BM). During the time of completing the transaction, three things instantaneously took place: (i) the account recognition module 170 in electronic receipt system 102 detected the business owner's qualification, eligibility and account in order to capture his transactional data relative to the purchase, in real-time; (ii) immediately following the first event, the transactional data 132 was captured and instantly sent to the remote electronic storage environments (central repository database 120) and data platforms, where it was converted into an electronic receipt 130; (iii) the business owner (BM) received a version of the electronic receipt 130 on his mobile smart phone 108c and was notified that his electronic receipt 130 was sent to his online account 140. Also, the merchant received a copy of the electronic receipt 130 in their destination account 140. These events took place seamlessly and in real-time.

‘Employee #1’ made a purchase, buying an airline ticket for an upcoming business trip, from an online travel company named ‘Travel XYZ’. She used her supplementary business smart card to complete the transaction, online. She followed the normal procedures for searching her ticket, continued on to the transaction process and entered her supplementary business smart card details on Travel XYZ's e-Commerce web pages. As Travel XYZ is also a subscribing merchant for receiving electronic receipts 130, they have embedded the electronic receipt system 102 comprising computer-related embodiments and software platforms into their e-commerce platform. During the transaction process, the account recognition module 170 captured, verified and identified that ‘Employee #1’ has met the qualification, eligibility and has a destination account 140 for having her financial transactional data 132 captured and converted in to an electronic receipt 130. Furthermore, electronic receipt system 102 also identified her as a supplementary accountholder SOSA3 to the subscribing business owner BMPA1. During the time of completing the transaction, three things instantaneously took place: (i) the account recognition module 170 of electronic receipt system 102 (comprising of software and hardware platforms) detected the supplementary account holder's SOSA3 qualification, eligibility and account in order to capture her financial transactional data 132 relative to the purchase, in real-time; (ii) immediately following the first event, the financial transactional data 132 was captured and instantly sent to the remote electronic storage environments (central repository database 120) and data platforms, where it was converted into an electronic receipt 130; (iii) the supplementary accountholder received a version of the electronic receipt 130 on her mobile smart phone 108c and was notified that her electronic receipt 130 was sent to her online account, and the business owner BMPA1 received a notification stating that Employee #1 just created an electronic receipt 130, expensing $XXX.XX with a merchant called ‘Travel XYZ’ within the Travel category. Also, the merchant (M) received a copy of the electronic receipt 130 in their account (discussed below). These events took place seamlessly and in real-time

The business owner created a Spend Alert SA1 on ‘Employee 2’, so that he can closely monitor his company's expense budget. He set a spend alert on ‘Employee #2’ by setting the parameters of $250 expense threshold on gasoline costs, in the Gas & Fuel category for the duration of August 1^{st}-August 31^{st}. During this period, Employee #2 reached the spend threshold and the business owner was immediately notified through SMS text messaging; an email to his email inbox; and a message was posted on his destination account 140. The notifications, which was triggered by threshold being met, informed him that the spend threshold has been reached. Through the Spend Alert notifications, the business owner was able to take swift action, as he so desires.

Through the subject embodiments, the business owner (BM) creates an expense management report EMR1 through his online account. The report allows him to see a dashboard view and a detailed view of his business expenses. Additionally, the business owner creates a dynamic report enabling him to categorize his expenses by search fields that include: time, merchant category and by his supplementary accounts. Through his report generation he can see that 2 months ago ‘Employee #1’ purchased her ticket to destination ‘X’ for the amount of $XXX.XX, through the travel company named ‘Travel XZY’; within the travel (merchant) category. He may also able to see all the subsequent expenses related to the business trip, such as restaurants and taxi fares, which went against the business smart card. In addition to creating expense reports, the business owner also examines the each electronic receipt, which contains full transaction line item details.

At the end of the business day, the office supplies merchant (M) is reconciling his card payments in order to process for payment with the Acquirer. As the merchant (M) is a subscriber, he simply accesses his online destination account 140 to view his electronic receipts for the day. Through the computer-related inventions, he has the capability of creating dynamic report generations. He creates his sales management report (SMR1) for the day and is able to separate and categorize all transactions made by each credit and debit card company (e.g. American Express® Cards, Discover® Cards, Diners Club® Cards, MasterCard® Cards, JCB Cards, Visa® Cards, etc.). Once his entire card payments have been separated, categorised and the amount totaled, his is able to electronically submit this to his Acquirer. This process takes place in a few steps (a few clicks), and dramatically reduces his administrative cost and his time. Consequently, he finds the service provides him a great amount of convenience and a new level of experience for his business and his customers. Consequently, he is able to allocate more productive time to his business. Furthermore, all his receipts are now electronically stored on his online account for 10 years rolling. Moreover, the sales management reports (SMR1) also allows the merchant to view this inventory management of his store, enabling him to effectively and efficiently reconcile and replenish his inventory stock of his business.

Travel XYZ wants to target a specific segment of the market with a promotion. They submit a request to the electronic receipt system 102 containing the description of the desired target profile segment. The electronic receipt system 102 conducts the necessary data mining and search within central repository database 120; identifies and creates the file containing the target profile list of subscribing customers. The travel company sends the marketing creative with the offer to the electronic receipt system 102. The electronic receipt system 102 then executes the delivery of the target profile marketing campaign by sending the offer through notifications (S6 in FIG. 1B) directly to the target list of subscribing customers, via the SMS text channel, email channel and to their online accounts 140.

Employee #3 receives an offer (MO1) from a subscribing merchant through the electronic receipt system 102, and their online destination account 140 and her hypermedia devices 108a/b/c, which she finds is of little relevance. Employee #3 posts her offer on the website associated through her online account, with the intention of trading her offer with another subscribing buyer (TMO1). Another subscribing buyer sends Employee #3 a message to her online account with a proposition to trade his offer with her, which he received from another subscribing merchant. Employee #3 accepts and electronically sends the official merchant offer to the other subscriber and he does the same. The two subscribers are greatly satisfied as they both found offers which they deem to be highly relevant for their needs. Also, the two subscribing merchants are both satisfied as they met their response rates and target goals for the campaign offer, and also got some valuable insights to their marketing campaign strategies of what effectively worked and what didn't.

Tax season has come around. The business owner (BM), the office supplies merchant (M) and the travel merchant (M) all have to submit their taxes. As all three businesses are subscribing to the services to receive electronic receipts 130 and the added services, they are all able to access their online accounts 140 and create their tax reports (TMR1) on the products and services they either bought or rendered (respectively). This can be done in a matter of a few clicks on their accounts 140. Furthermore, as the computer-related embodiments are registered with the Government Tax Agency, subscribing businesses (BM) and merchants (M) are able to directly submit their respective business/commercial taxes for the year, and any year thereafter. By merely having the electronic receipts 130 stored on their online account, these businesses never ever have to physically manage and store paper receipts again—saving them on storage costs, nor do they have to incur accounting/book-keeping costs to have the taxes managed as this will be calculated through the inventions.

Electronic receipt system 102 may also allow the creation of a business directory and the capability of each subscribing buyer (A, BM) to create their own custom business directory; the office supplies merchant (M) was able to post an ad for his business on the general business directory. Also through the enhancement of the business directory feature, the business owner was able to create his own custom business directory listings on his online account 140. The business owner's custom directory consists of subscribing merchants that he tagged and placed in his own business directory. In addition to his own custom business directory, the electronic receipt system 102 also provided the business owner with a list of alternative merchants who offer similar products and services. As an enhanced service to the directory service, the inventions also allowed the business owner to post a rating and a limited text description regarding the services rendered by the office supplies merchant (M) and Travel XYZ (M). These ratings and text descriptions are available to be seen by other subscribing customers on the company website.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. A computer implemented system of processing a financial transaction at a point-of-sale terminal, the system comprising
one or more distributed processors; and
one or more memories for storing information and at least one set of instructions which, when executed by the one or more distributed processors, cause the one or more distributed processors to:
capture financial transaction data;
identify a destination account at a remote data storage facility;
send the financial transaction data to the remote data storage facility;
generate an electronic receipt from the financial transaction data; and
store the electronic receipt at the destination account at the remote data storage facility;
wherein
the destination account is associated with an account type; and
the electronic receipt is configurable to contain a variable amount of merchant level data based on the account type.

2. The system of claim 1 wherein the account type of the destination account that stores the electronic receipt is selected from a group consisting of: a consumer type, a business manager type, and a merchant type.

3. The system of claim 1, wherein when identifying the destination account, the one or more processors is further configured to:
request financial account information used for payment during the financial transaction;
determine if the destination account corresponding to the financial account information exists; and
if the destination account does not exist, create the destination account as corresponding to the financial account information.

4. The system of claim 3, wherein the financial account information is at least one selected from a group consisting of: credit card accounts, debit card accounts, bank accounts, smart cards, charge cards, contactless payment, biometric payment and mobile payment.

5. The system of claim 1, wherein the financial transaction is initiated with a mobile application on the mobile device, and wherein the mobile application comprises a monetary value of a payment method.

6. The system of claim 5, wherein the mobile application is configurable to display a barcode for indicating the payment method and the destination account.

7. The system of claim 1, wherein the electronic receipt comprises contact information for contacting a financial institution holding the source of payment funds, and the contact information, when accessed, is configured to cause a freeze to be placed on the payment funds.

8. A computer implemented system for processing a financial transaction at a point-of-sale terminal, the system comprising
one or more distributed processors; and
one or more memories for storing information and at least one set of instructions which, when executed by the one or more distributed processors, cause the one or more processors to:
determine multiple destination accounts stored on a remote data storage facility;
generate at least one electronic receipt for each of the multiple destination accounts; and
send the at least one electronic receipt to each of the multiple destination accounts at the remote data storage facility.

9. The system of claim 8, wherein the multiple destination accounts comprise a primary account and at least one supplementary account.

10. The system of claim 9, wherein the one or more distributed processors is further configured to send spend alerts to a primary account if the financial transaction involved the at least one supplementary account.

11. The system of claim 8, wherein the financial transaction occurs at a physical location, and at least one of the multiple destination accounts belongs to an account holder not present at the physical location of the financial transaction.

12. The system of claim 9, wherein the primary account corresponds to an employer account, and the supplementary account corresponds to an employee account associated with the employer account.

13. A computer implemented system for storing electronic receipts comprising:
a processor; and
a memory storing a plurality of instructions, which when executed by the processor, causes the processor to provide:
a merchant module operable to store merchant account data;
a consumer module operable to store consumer account data;
a business manager module operable to store business account data;
a receipts module operable to store electronic receipts associated with the merchant account data and the consumer account data; and
a hypermedia interface for interacting with the electronic receipts.

14. The system of claim 13, wherein the interacting with the electronic receipts by the hypermedia interface comprises one selected from the group consisting of: viewing, searching, printing and downloading.

15. The system of claim 13, wherein the hypermedia interface is implemented by one or more of the following: an application programming interface, a website, a web portal, a mobile website, a mobile application, and a smartphone application.

16. The system of claim 13, wherein
the merchant module is configured to generate merchant promotions; and
the hypermedia interface is configured to send the merchant promotions to a consumer account with valid consumer account data.

17. The system of claim 16, wherein the hypermedia interface is further configured to allow trading of the merchant promotions between the consumer account and another consumer account with valid consumer account data.

18. The system of claim 13, wherein the hypermedia interface is configured to provide a business directory based on the merchant account data.

19. The system of claim 18, wherein the business directory is tailored for a consumer account based on consumer account data associated with the consumer account.

20. The system of claim 18, wherein the business directory is tailored for a merchant account based on merchant account data associated with the merchant account.
